(19) United States
(12) Patent Application Publication
(10) Pub. No.: US 2025/0164823 A1
(43) Pub. Date: May 22, 2025

(54) EMBEDDED CONTACT LENS WITH A HIGH REFRACTIVE INDEX INSERT THEREIN

(71) Applicant: Alcon Inc., Fribourg (CH)

(72) Inventors: Ya-Wen Chang, Alpharetta, GA (US); Steve Yun Zhang, Sugar Hill, GA (US)

(21) Appl. No.: 18/951,833

(22) Filed: Nov. 19, 2024

Related U.S. Application Data
(60) Provisional application No. 63/600,840, filed on Nov. 20, 2023.

(51) Int. Cl. G02C 7/04; G02B 1/04

(52) U.S. Cl. CPC G02C 7/049; G02B 1/043; G02C 2202/20

(57) ABSTRACT

The invention provides a composite material suitable for making hydrogel contact lenses and especially diffractive inserts to be embedded in hydrogel contact lenses. A composite material of the invention has a relatively high refractive index (RI) and is composed of a hydrogel material and high RI nanoparticles which are distributed in the polymer matrix of the hydrogel material and present in an amount sufficient high to provide the composite material with a high RI but sufficient low to provide the composite material with a light transmissibility of 85% or greater in the range between 450 to 700 nm.

This application claims the benefit under 35 USC § 119 (e) of U.S. provisional application No. 63/600,840 filed 20 Nov. 2023, herein incorporated by reference in its entirety.

The present invention relates to an embedded hydrogel contact lens with a diffractive insert embedded therein that has a high refractive index (RI) and made of a composite material composed of a hydrogel material and high refractive index (RI) nanoparticles distributed in the polymer matrix of the hydrogel material.

### BACKGROUND OF THE INVENTION

Presbyopia is a well-known disorder in which the eye loses its ability to focus at close distance, affecting more than 2 billion patients worldwide. Extensive research efforts have been contributed to develop multifocal ophthalmic lenses (intraocular lenses or contact lenses) for correcting presbyopia. One of extensive research areas is the development of multifocal diffractive ophthalmic lenses. See, for example, U.S. Pat. Nos. 4,210,391, 4,338,005, 4,340,283, 4,637,697, 4,641,934, 4,642,112, 4,655,565, 4,830,481, 4,881,804, 4,881,805, 4,936,666, 4,995,714, 4,995,715, 5,054,905, 5,056,908, 5,076,684, 5,100,226, 5,104,212, 5,114,220, 5,116,111, 5,117,306, 5,120,120, 5,121,979, 5,121,980, 5,229,797, 5,748,282, 5,760,871, 5,982,543, 6,120,148, 6,364,483, 6,536,899, 6,951,391, 6,957,891, 7,025,456, 7,073,906, 7,093,938, 7,156,516, 7,188,949, 7,232,218, 7,891,810, 8,038,293, 8,128,222, 8,142,016, 8,382,281, 8,480,228, 8,556,416, 8,573,775, 8,678,583, 8,755,117, 9,033,494, 9,310,624, 9,320,594, 9,370,416, 10,197,815, 10,209,533, 10,426,599, 10,463,474, 10,524,899, 10,675,146, 10,725,320, 10,932,901, and 10,945,834. Currently, multifocal diffractive intraocular lenses are commercially available for correcting presbyopia.

However, multifocal diffractive contact lenses are still not commercially available for correcting presbyopia (see, Pérez-Prados, et al., “Soft Multifocal Simultaneous Image Contact Lenses: Review”, Clin. Exp. Optom. 2017, 100:107-127) probably due to some issues uniquely associated with contact lenses. For example, the standard lens materials have a refractive index of about 1.42 or less, i.e., about 0.04 higher than the refractive index of tear film. With such a small difference in refractive index, a higher diffraction grating height needs to be created on one of the anterior and posterior surfaces of a contact lens. But, contact lenses require smooth anterior and posterior surfaces for wearing comfort. Such a diffraction grating likely causes discomfort to a patient.

In recent years, it has been proposed that various inserts can be incorporated in hydrogel contact lenses for various purposes, e.g., for corneal health, vision correction, diagnosis, etc. See, for example, U.S. Pat. Nos. 4,268,132, 4,401,371, 5,098,546, 5,156,726, 6,851,805, 7,490,936, 7,883,207, 8,154,804, 8,215,770, 8,348,424, 8,874,182, 9,176,332, 9,618,773, 10,203,521, and 10,209,534; and U.S. Pat. Appl. Pub. Nos. 20040141150, 20040212779, 2008/0208335, 2009/0091818, 20090244477, 2010/0072643, 2010/0076553, 20110157544, 2012/0120365, 2012/0140167, 2012/0234453, 2014/0276481, and 2015/0145155).

U.S. Pat. Appl. Pub. Nos. 2021/0191153 A1, 2021/0191154A1 and 2023/0004023A1 disclose contact lenses with an embedded diffractive optic insert therein for correction of presbyopia. For making such embedded contact lenses, an insert needs to be made of a material having a relatively high refractive index. To increase the refractive index of an insert material, phenyl-containing components are typically incorporated into the polymer matrix of a polymeric material. For instance, U.S. Pat. No. 6,657,030 B2 discloses the use of phenyl-containing monomers/HEMA comonomers to make high refractive index hydrogel compositions for ophthalmic implants. It reported that a RI of about 1.52 could be achieved. WO2015023001A1, EP2374832A1, US20230004023A1 and US20220306810A1 also disclose use of phenyl-containing components to increase the refractive index of polymeric materials. However, the incorporation of phenyl-containing components in polymer materials could limit their use and achievable RI ranges.

Therefore, there is still a need for a material having a high refractive index and suitable for forming diffractive optic inserts for making embedded diffractive contact lenses.

### SUMMARY OF THE INVENTION

In one aspect, the invention provides an embedded contact lens comprising a lens body that has an anterior surface, an opposite posterior surface, and a diameter of from about 12.5 mm to about 15.5 mm, wherein the lens body is composed of a first hydrogel material having a first refractive index in fully-hydrated state and an insert embedded in the first hydrogel material, wherein the insert is circular and concentric with a central axis of the lens body and has a convex surface, an opposite concave surface, and a diameter of from about 5.0 mm to about 11.5 mm, wherein the insert is made of a composite material composed of a second hydrogel material and nanoparticles distributed in the polymer matrix of the second hydrogel material, wherein the nanoparticles are nanocrystals of titanium dioxide or zirconia dioxide and are surface-functionalized to contain reactive or non-reactive functional groups thereon, wherein the insert in fully-hydrated state has a second refractive index that is at least 0.03 higher than the first refractive index and has a visible light transmittance of 85% or greater between 450 nm to 700 nm.

In another aspect, the invention provides an hydrogel ophthalmic device that is a contact lens or an insert, wherein the hydrogel ophthalmic device is made of a composite material composed of a hydrogel material and nanoparticles distributed in the polymer matrix of the hydrogel material, wherein the nanoparticles are nanocrystals of titanium dioxide or zirconia dioxide and are surface-functionalized to contain reactive or non-reactive functional groups thereon, wherein the composite material in fully hydrated state has a refractive index of at least 1.46 and a visible light transmittance of 85% or greater between 450 nm to 700 nm.

The present invention provides the foregoing and other features, and the advantages of the invention will become further apparent from the following detailed description of the presently preferred embodiments, read in conjunction with the accompanying figures. The detailed description and figures are merely illustrative of the invention and do not limit the scope of the invention, which is defined by the appended claims and equivalents thereof.

### BRIEF DESCRIPTION OF DRAWINGS

FIG. 1 schematically illustrates an embedded hydrogel contact lens according to a preferred embodiment of the invention.

FIG. 2 schematically illustrates an embedded hydrogel contact lens according to a preferred embodiment of the invention.

FIG. 3 schematically illustrates an embedded hydrogel contact lens according to a preferred embodiment of the invention.

FIG. 4 illustrates the general dimensions of a contact lens to be measured.

### DESCRIPTION OF PREFERRED EMBODIMENTS

Unless defined otherwise, all technical and scientific terms used herein have the same meaning as commonly understood by one of ordinary skill in the art to which this invention belongs. Generally, the nomenclature used herein and the laboratory procedures are well known and commonly employed in the art. Conventional methods are used for these procedures, such as those provided in the art and various general references. Where a term is provided in the singular, the inventors also contemplate the plural of that term. The nomenclature used herein and the laboratory procedures described below are those well-known and commonly employed in the art.

“About” as used herein in this application means that a number, which is referred to as “about”, comprises the recited number plus or minus 1-10% of that recited number.

“Contact Lens” refers to a structure that can be placed on or within a wearer's eye. A contact lens can correct, improve, or alter a user's eyesight, but that need not be the case.

A “hydrogel contact lens” refers to a contact lens comprising a hydrogel material as bulk material (i.e., a hydrogel bulk material).

A “hydrogel” or “hydrogel material” refers to a crosslinked polymeric material which has three-dimensional polymer networks (i.e., polymer matrix), is insoluble in water, but can hold at least 10% by weight of water in its polymer matrix when it is fully hydrated (or equilibrated). A hydrogel material can be a non-silicone hydrogel material or a silicone hydrogel material.

A “non-silicone hydrogel” or “non-silicone hydrogel material” refers to a hydrogel material that is theoretically free of silicone.

A “silicone hydrogel,” “SiHy,” “silicone hydrogel material,” or “SiHy material” refers to a silicone-containing hydrogel obtained by copolymerization of a polymerizable composition comprising at least one silicone-containing monomer or at least one silicone-containing macromer or at least one crosslinkable silicone-containing prepolymer.

A siloxane, which often also described as a silicone, refers to a molecule having at least one moiety of —Si—O—Si— where each Si atom carries two organic groups as substituents.

An “embedded hydrogel contact lens” refers a hydrogel contact lens comprising a hydrogel material as the major lens material of the contact lens (i.e., bulk material) and at least one insert embedded therein and made of a polymeric material.

In accordance with the invention, an “insert” refers to any 3-dimensional circular disk which is made of a hydrogel material and has a diameter of from about 5.0 mm to about 11.5 mm and a thickness less than any thickness of the lens body of an embedded hydrogel contact lens in the region where the insert is embedded.

The term “anterior surface”, “front surface”, “front curve surface” or “FC surface” in reference to a contact lens or an insert, as used in this application, interchangeably means a surface of the contact lens or insert that faces away from the eye during wear. The anterior surface (FC surface) is convex.

The “posterior surface”, “back surface”, “base curve surface” or “BC surface” in reference to a contact lens or insert, as used in this application, interchangeably means a surface of the contact lens or insert that faces towards the eye during wear. The posterior surface (BC surface) is concave.

A “central axis” in reference to a contact lens or lens body, as used in this application, means an imaginary reference line passing through the geometrical centers of the anterior and posterior surfaces of a contact lens or a lens body.

The diameter of a contact lens or an insert is the width of the contact lens or the insert from the outmost edge to the outmost edge, as well known to a skilled person.

“Hydrophilic,” as used herein, describes a material or portion thereof that will more readily associate with water than with lipids.

A “vinylic monomer” refers to a compound that has one sole ethylenically unsaturated group, is soluble in a solvent, and can be polymerized actinically or thermally.

The term “soluble”, in reference to a compound or material in a solvent, means that the compound or material can be dissolved in the solvent to give a solution with a concentration of at least about 0.5% by weight at room temperature (i.e., a temperature of about 21° C. to about 27° C.).

The term “insoluble”, in reference to a compound or material in a solvent, means that the compound or material can be dissolved in the solvent to give a solution with a concentration of less than 0.01% by weight at room temperature (as defined above).

The term “ethylenically unsaturated group” is employed herein in a broad sense and is intended to encompass any groups containing at least one >C═CH₂ group. Exemplary ethylenically unsaturated groups include without limitation (meth)acryloyl (

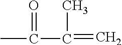

and/or),

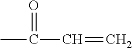

), allyl, vinyl, styrenyl, or other C═C containing groups.

As used herein, “actinically” in reference to curing, crosslinking or polymerizing of a polymerizable composition, a prepolymer or a material means that the curing (e.g., crosslinked and/or polymerized) is performed by actinic irradiation, such as, for example, UV irradiation, ionizing radiation (e.g. gamma ray or X-ray irradiation), microwave irradiation, and the like. Thermal curing or actinic curing methods are well-known to a person skilled in the art.

The term “(meth)acrylamide” refers to methacrylamide and/or acrylamide.

The term “(meth)acrylate” refers to methacrylate and/or acrylate.

An “aryl vinylic monomer” refers to a vinylic monomer having an aromatic ring.

A “hydrophilic vinylic monomer” refers to a vinylic monomer which typically yields a homopolymer that is water-soluble or can absorb at least 10 percent by weight of water.

A “hydrophobic vinylic monomer” refers to a vinylic monomer which typically yields a homopolymer that is insoluble in water and can absorb less than 10% by weight of water.

As used in this application, the term “vinylic crosslinker” refers to an organic compound having at least two ethylenically unsaturated groups. A “vinylic crosslinking agent” refers to a vinylic crosslinker having a molecular weight of 700 Daltons or less.

An “aryl vinylic crosslinker” refers to a vinylic crosslinker having an aromatic ring.

A “silicone-containing vinylic monomer or crosslinker” or a “siloxane-containing vinylic monomer or crosslinker” interchageably refers to a vinylic monomer or crosslinker having at least one moiety of —Si—O—Si— where each Si atom carries at least two organic substituents.

A “polysiloxane segment” or “polydiorganosiloxane segment” interchangeably refers to a polymer chain segment (i.e., a divalent radical) of

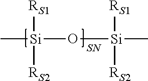

in which SN is an integer of 3 or larger and each of R_{S1} and R_{S2} independent of one another are selected from the group consisting of: C₁-C₁₀ alkyl; phenyl; C₁-C₄-alkyl-substituted phenyl; C₁-C₄-alkoxy-substituted phenyl; phenyl-C₁-C₆-alkyl; C₁-C₁₀ fluoroalkyl; C₁-C₁₀ fluoroether; aryl; aryl C₁-C₁₈ alkyl; -alk-(OC₂H₄)_{γ1}—OR^{o} (in which alk is C₁-C₆ alkylene diradical, R^{o} is H or C₁-C₄ alkyl and γ1 is an integer from 1 to 10); a C₂-C₄₀ organic radical having at least one functional group selected from the group consisting of hydroxyl group (—OH), carboxyl group (—COOH), amino group (—NR_{N1}R_{N1}′), amino linkages of —NR_{N1}—, amide linkages of —CONR_{N1}—, amide of —CONR_{N1}R_{N1}′, urethane linkages of —OCONH—, and C₁-C₄ alkoxy group, or a linear hydrophilic polymer chain, in which R_{N1} and R_{N1}′ independent of each other are hydrogen or a C₁-C₁₅ alkyl; and an organic radical having up to 45 carbon atoms.

A “polydiorganosiloxane vinylic crosslinker” or polysiloxane vinylic crosslinker” interchangeably refers to a compound comprising at least one polysiloxane segment and at least two ethylenically-unsaturated groups. An “aryl polysiloxane vinylic crosslinker” refers to a polysiloxane vinylic crosslinker having an aromatic ring.

The term “fluid” as used herein indicates that a material is capable of flowing like a liquid.

As used in this application, the term “clear” in reference to a polymerizable composition means that the polymerizable composition is a transparent solution or liquid mixture having a light transmissibility of 85% or greater (preferably 90% or greater) in the range between 400 to 700 nm.

As used in this application, the term “polymer” means a material formed by polymerizing or crosslinking one or more monomers or macromers or prepolymers or combinations thereof.

A “macromer” or “prepolymer” refers to a compound or polymer that contains ethylenically unsaturated groups and has a number average molecular weight of greater than 700 Daltons.

As used in this application, the term “molecular weight” of a polymeric material (including monomeric or macromeric materials) refers to the number-average molecular weight unless otherwise specifically noted or unless testing conditions indicate otherwise. A skilled person knows how to determine the molecular weight of a polymer according to known methods, e.g., GPC (gel permeation chromatochraphy) with one or more of a refractive index detector, a low-angle laser light scattering detector, a multi-angle laser light scattering detector, a differential viscometry detector, a UV detector, and an infrared (IR) detector; MALDI-TOF MS (matrix-assisted desorption/ionization time-of-flight mass spectroscopy); ¹H NMR (Proton nuclear magnetic resonance) spectroscopy, etc.

The term “monovalent radical” refers to an organic radical that is obtained by removing a hydrogen atom from an organic compound and that forms one bond with one other group in an organic compound. Examples include without limitation, alkyl (by removal of a hydrogen atom from an alkane), alkoxy (or alkoxyl) (by removal of one hydrogen atom from the hydroxyl group of an alkyl alcohol), thiyl (by removal of one hydrogen atom from the thiol group of an alkylthiol), cycloalkyl (by removal of a hydrogen atom from a cycloalkane), cycloheteroalkyl (by removal of a hydrogen atom from a cycloheteroalkane), aryl (by removal of a hydrogen atom from an aromatic ring of the aromatic hydrocarbon), heteroaryl (by removal of a hydrogen atom from any ring atom), amino (by removal of one hydrogel atom from an amine), etc.

The term “divalent radical” refers to an organic radical that is obtained by removing two hydrogen atoms from an organic compound and that forms two bonds with other two groups in an organic compound. For example, an alkylene divalent radical (i.e., alkylenyl) is obtained by removal of two hydrogen atoms from an alkane, a cycloalkylene divalent radical (i.e., cycloalkylenyl) is obtained by removal of two hydrogen atoms from the cyclic ring.

In this application, the term “substituted” in reference to an alkyl or an alkylenyl means that the alkyl or the alkylenyl comprises at least one substituent which replaces one hydrogen atom of the alkyl or the alkylenyl and is selected from the group consisting of hydroxyl (—OH), carboxyl (—COOH), —NH₂, sulfhydryl (—SH), C₁-C₄ alkyl, C₁-C₄ alkoxy, C₁-C₄ alkylthio (alkyl sulfide), C₁-C₄ acylamino, C₁-C₄ alkylamino, di-C₁-C₄ alkylamino, and combinations thereof.

The term “terminal ethylenically-unsaturated group” refers to one ethylenically-unsaturated group at one of the two ends of the main chain (or backbone) of an organic compound as known to a person skilled in the art.

A free radical initiator can be either a photoinitiator or a thermal initiator. A “photoinitiator” refers to a chemical that initiates free radical crosslinking/polymerizing reaction by the use of light. A “thermal initiator” refers to a chemical that initiates radical crosslinking/polymerizing reaction by the use of heat energy.

“Post-curing surface treatment”, in reference to a silicone hydrogel bulk material or a SiHy contact lens, means a surface treatment process that is performed after the silicone hydrogel bulk material or the SiHy contact lens is formed by curing (i.e., thermally or actinically polymerizing) a SiHy lens formulation.

The term “silicone hydrogel lens formulation” or “SiHy lens formulation” interchangeably refers to a polymerizable composition that comprises all necessary polymerizable components for producing a silicone hydrogel (SiHy) contact lens or a SiHy lens bulk material as well known to a person skilled in the art.

A visible light transmittance between 450 nm to 700 nm refers to an averaged percentage transmission between 450 nm to 700 nm.

In general, the invention is directed to a composite material suitable for making hydrogel contact lenses and especially diffractive inserts to be embedded in hydrogel contact lenses. A composite material of the invention has a relatively high refractive index (RI) and is composed of a hydrogel material and high RI nanoparticles which are distributed in the polymer matrix of the hydrogel material and present in an amount sufficient high to provide the composite material with a high RI but sufficient low to provide the composite material with an optical transparency (i.e., a light transmittance of 85% or greater, preferably 90% or greater, in the range between 450 to 700 nm).

The present invention is partly based on the discoveries that nanocrystals of titanium dioxide or zirconia dioxide can be surface-functionalized to contain non-reactive functional groups or preferably reactive functional groups (e.g., (methacryloyl or acryloyl groups) thereon to (1) ensure binding of the nanocrystals (i.e., nanoparticles) to the hydrogel network (2) prevent aggregation and provide stability in formulations and that such surface-functionalized nanocrystals are compatible with the components in a typical hydrogel lens-forming composition and can be easily added into a known lens-forming composition for cast-molding of high RI hydrogel contact lenses and diffractive inserts.

There are some potential unique features associated with use of a composite material of the invention in making a diffractive insert or hydrogel contact lens having a relatively high RI (refractive index).

First, a diffractive insert with a high RI can be used to make embedded diffractive multifocal hydrogel contact lenses; and a high RI hydrogel contact lens can have a thinner thickness so as to have a higher oxygen transmissibility.

Second, a diffractive insert and a high RI hydrogel contact lens can be made for a polymerizable composition obtained simply by adding surface-functionalized nanoparticles into an existing lens-forming composition.

The present invention, in one aspect, provides an embedded contact lens comprising a lens body that has an anterior surface, an opposite posterior surface, and a diameter of from about 12.5 mm to about 15.5 mm, wherein the lens body is composed of a first hydrogel material having a first refractive index in fully-hydrated state and an insert embedded in the first hydrogel material, wherein the insert is circular and concentric with a central axis of the lens body and has a convex surface, an opposite concave surface, and a diameter of from about 5.0 mm to about 11.5 mm (preferably from about 5.5 mm to about 10.0 mm, more preferably from about 6.0 mm to about 9.0 mm), wherein the insert is made of a composite material composed of a second hydrogel material and nanoparticles distributed in the polymer matrix of the second hydrogel material, wherein the nanoparticles are nanocrystals of titanium dioxide or zirconia dioxide and are surface-functionalized to contain reactive or non-reactive functional groups thereon, wherein the insert in fully-hydrated state has a second refractive index that is at least 0.03 (preferably at least 0.04, more preferably at least 0.05, even more preferably at least 0.06) higher than the first refractive index and a visible light transmittance of about 85% or greater (preferably about 90% or greater) between 450 nm to 700 nm.

In various preferred embodiments, the composite material in fully hydrated state has a water content of from about 10% to about 60% (preferably from about 10% to about 50%, more preferably from about 10% to about 40%) and a refractive index of at least 1.44 (preferably at least 1.45, more preferably at least 1.46, even more preferably at least 1.47).

Surface-functionalized nanocrystals of TiO₂ and ZrO₂ can be obtained from commercial sources, e.g., Pixelligent which provides Pixelligent PixClear® Zirconia nanocrystal suspensions and Titania nanocrystal suspensions (PCPB-2-50, PCPN-50-ETA, PCPG-2-50-ETA, PCPC-1-50-ETA, PCPR-50-ETA) with functional groups thereon. The functional groups on the surfaces of nanocrystals can be methacrylate, acrylate or non-reactive functional groups. Preferably, the functional groups are methacrylate or acrylate groups. Those commercially available nanoparticles have a refractive index from about 1.7 to about 1.9.

In a preferred embodiment, the nanoparticles are surface-functionalized to contain (meth)acryloyl groups. By having such reactive functional groups on the surfaces of the nanoparticles, the nanoparticles can be covalently bound to the polymer matrix of the second hydrogel material (of the insert) and will not be extracted out of the embedded hydrogel contact lens during extraction/hydration and/or any post-molding processes.

In accordance with the invention, the first hydrogel material can be: a non-silicone hydrogel material that comprises repeating units of at least one hydrophilic vinylic monomers and repeating units of at least one non-silicone vinylic crosslinker; or a silicone hydrogel material that comprises repeating units of at least one hydrophilic vinylic monomers and repeating units of at least one silicone-containing vinylic monomer and/or at least one polysiloxane vinylic crosslinker.

Where the first hydrogel material is a non-silicone hydrogel material, it can be formed from a non-silicone hydrogel lens formulation (i.e., a first polymerizable composition) as known to a person skilled in the art. Typically, a non-silicone hydrogel lens formulation is free of any silicone-containing polymerizable component and is a monomer mixture comprising (a) at least one hydrophilic vinylic monomer, (b) at least one non-silicone vinylic crosslinker, (c) a free-radical initiator (photoinitiator or thermal initiator), and (d) at least one component selected from the group consisting of a non-silicone hydrophobic vinylic monomer, a UV-absorbing vinylic monomer, a high-energy-violet-light (“HEVL”) absorbing vinylic monomer, a visibility tinting agent (e.g., reactive dyes, polymerizable dyes, pigments, or mixtures thereof), and combinations thereof.

Where the first hydrogel material is a silicone hydrogel material, it can be formed from a silicone hydrogel lens formulation (i.e., a first polymerizable composition) as known to a person skilled in the art. Typically, a silicone hydrogel lens formulation is a monomer mixture comprising (a) at least one hydrophilic vinylic monomer, (b) at least one silicone-containing polymerizable component which is a silicone-containing vinylic monomer and/or a polysiloxane vinylic crosslinker, (c) a free-radical initiator (photoinitiator or thermal initiator), and (d) at least one component selected from the group consisting of a non-silicone vinylic crosslinker, a non-silicone hydrophobic vinylic monomer, a UV-absorbing vinylic monomer, a high-energy-violet-light (“HEVL”) absorbing vinylic monomer, a visibility tinting agent (e.g., reactive dyes, polymerizable dyes, pigments, or mixtures thereof), and combinations thereof.

In accordance with the invention, the second hydrogel material can be: a non-silicone hydrogel material that comprises repeating units of at least one hydrophilic vinylic monomers, repeating units of at least one non-silicone vinylic crosslinker, and optionally but preferably repeating units of at least one aryl vinylic monomer and/or at least one aryl vinylic crosslinker; or a silicone hydrogel material that comprises repeating units of at least one hydrophilic vinylic monomers, repeating units of at least one silicone-containing vinylic monomer and/or at least one polysiloxane vinylic crosslinker, and optionally but preferably repeating units of at least one aryl vinylic monomer and/or at least one aryl vinylic crosslinker. It is understood that a second hydrogel material comprising repeating units of at least one aryl vinylic monomer and/or at least one aryl vinylic crosslinker, in combination with nanoparticles, can impart a higher refractive index to the composite material of the invention.

Where the second hydrogel material of the composite material is a non-silicone hydrogel material, the composite material can be formed from a second polymerizable composition which can be prepared by adding surface-functionalized nanoparticles into a non-silicone-hydrogel lens formulation (polymerizable composition) as known to a person skilled in the art. Typically, a second polymerizable composition for forming a composition material is free of any silicone-containing polymerizable component and comprises (a) at least one hydrophilic vinylic monomer, (b) at least one non-silicone vinylic crosslinker, (c) a free-radical initiator (photoinitiator or thermal initiator), (d) surface-functionalized nanoparticles, and (e) at least one component selected from the group consisting of an aryl vinylic monomer, an aryl vinylic crosslinker, a non-silicone hydrophobic vinylic monomer, a UV-absorbing vinylic monomer, a high-energy-violet-light (“HEVL”) absorbing vinylic monomer, a visibility tinting agent (e.g., reactive dyes, polymerizable dyes, pigments, or mixtures thereof), and combinations thereof.

Where the second hydrogel material of the composite material is a silicone hydrogel material, the composite material can be formed from a second polymerizable composition which can be prepared by adding surface-functionalized nanoparticles into a silicone-hydrogel lens formulation (polymerizable composition) as known to a person skilled in the art. Typically, a second polymerizable composition comprises (a) at least one hydrophilic vinylic monomer, (b) at least one silicone-containing polymerizable component which is a silicone-containing vinylic monomer and/or a polysiloxane vinylic crosslinker, (c) a free-radical initiator (photoinitiator or thermal initiator), (d) surface-functionalized nanoparticles, and (e) at least one component selected from the group consisting of an aryl vinylic monomer, an aryl vinylic crosslinker, a non-silicone vinylic crosslinker, a non-silicone hydrophobic vinylic monomer, a UV-absorbing vinylic monomer, a high-energy-violet-light (“HEVL”) absorbing vinylic monomer, a visibility tinting agent (e.g., reactive dyes, polymerizable dyes, pigments, or mixtures thereof), and combinations thereof.

Any suitable hydrophilic vinylic monomers can be used in the invention for forming the first and second hydrogel materials in combination with other polymerizable components. Various hydrophilic vinylic monomers have been used in various polymerizable compositions for forming non-silicone hydrogel materials and silicone hydrogel materials. Examples of preferred hydrophilic vinylic monomers include without limitation hydroxyethyl (meth)acrylate, glycerol (meth)acrylate, N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, di(ethylene glycol) (meth)acrylate, tri(ethylene glycol) (meth)acrylate, tetra(ethylene glycol) (meth)acrylate, N,N-dimethy (meth)acrylamide, (meth)acrylamide, N-ethyl (meth)acrylamide, N,N-diethyl (meth)acrylamide, N-propyl (meth)acrylamide, N-isopropyl (meth)acrylamide, N-3-methoxy-propyl (meth)acrylamide, N-vinylpyrrolidone, N-vinyl-N-methyl acetamide, N-vinyl-N-ethyl acetamide, N-vinyl-N-ethyl formamide, 1-methyl-3-methylene-2-pyrrolidone, 1-methyl-5-methylene-2-pyrrolidone, -methyl-3-methylene-2-pyrrolidone, N-2-hydroxyethyl vinyl carbamate, N-carboxyvinyl-β-alanine (VINAL), N-carboxyvinyl-α-alanine, a phosphorylcholine-containing vinylic monomer, and combinations thereof.

Examples of preferred phosphorylcholine-containing vinylic monomers include without limitation (meth)acryloyloxyethyl phosphorylcholine, (meth)acryloyloxypropyl phosphorylcholine, 4-((meth)acryloyloxy)butyl-2′-(trimethylammonio)ethylphosphate, 2-[(meth)acryloylamino]ethyl-2′-(trimethylammonio)-ethylphosphate, 3-[(meth)acryloylamino]-propyl-2′-(trimethylammonio)ethylphosphate, 4-[(meth)acryloylamino]butyl-2′-(trimethyl-ammonio)ethylphosphate, 5-((meth)acryloyloxy)pentyl-2′-(trimethylammonio)ethyl phosphate, 6-((meth)acryloyloxy) hexyl-2′-(trimethylammonio)-ethylphosphate, 2-((meth)acryloyloxy)ethyl-2′-(triethylammonio)ethylphosphate, 2-((meth)acryloyloxy)ethyl-2′-(tripropylammonio)ethylphosphate, 2-((meth)acryloyloxy)ethyl-2′-(tributylammonio)ethyl phosphate, 2-((meth)acryloyloxy)propyl-2′-(trimethylammonio)-ethylphosphate, 2-((meth)acryloyloxy)butyl-2′-(trimethylammonio)ethylphosphate, 2-((meth)acryloyloxy)pentyl-2′-(trimethylammonio)ethylphosphate, 2-((meth)acryloyloxy) hexyl-2′-(trimethylammonio)ethyl phosphate, 2-(vinyloxy)ethyl-2′-(trimethylammonio)ethylphosphate, 2-(allyloxy)ethyl-2′-(trimethylammonio)ethylphosphate, 2-(vinyloxycarbonyl)ethyl-2′-(trimethylammonio)ethyl phosphate, 2-(allyloxycarbonyl)ethyl-2′-(trimethylammonio)-ethylphosphate, 2-(vinylcarbonyl-amino)ethyl-2′-(trimethylammonio)ethylphosphate, 2-(allyloxycarbonylamino)ethyl-2′-(trimethylammonio)ethyl phosphate, 2-(butenoyloxy)ethyl-2′-(trimethylammonio)-ethylphosphate, and combinations thereof.

Any suitable no-silicone hydrophobic vinylic monomers can be used in the invention for forming the first and second hydrogel materials in combination with other polymerizable components. Examples of preferred hydrophobic non-silicone vinylic monomers include without limitation methyl (meth)acrylate, ethyl (meth)acrylate, methoxyethyl (meth)acrylate, propyl (meth)acrylate, isopropyl (meth)acrylate, cyclohexyl (meth)acrylate, 2-ethylhexyl (meth)acrylate, isobornyl (meth)acrylate, (meth)acrylonitrile, etc.), 2,2,2-trifluoroethyl (meth)acrylate, tetrafluoropropyl (meth)acrylate, hexafluoro-iso-propyl (meth)acrylate, hexafluorobutyl (meth)acrylate, heptafluorobutyl (meth)acrylate, octafluoropentyl (meth)acrylate, heptadecafluorodecyl (meth)acrylate, pentafluorophenyl (meth)acrylate, vinyl acetate, vinyl propionate, vinyl butyrate, vinyl valerate, vinyl ethyl ether, propyl vinyl ether, n-butyl vinyl ether, isoputyl vinyl ether, cyclohexyl vinyl ether, t-butyl vinyl ether, styrene, vinyl toluene, vinyl chloride, vinylidene chloride, 1-butene, and combinations thereof.

Any suitable no-silicone vinylic crosslinkers can be used in the invention for forming the first and second hydrogel materials in combination with other polymerizable components. Examples of preferred non-silicone vinylic crosslinkers include without limitation ethylene glycol di(meth)acrylate; 1,3-propanediol di(meth)acrylate; 2,3-propanediol di(meth)acrylate; 1,3-butanediol di-(meth)acrylate; 1,4-butanediol di(meth)acrylate; glycerol 1,3-diglycerolate di-(meth)acrylate; 1,5-pentanediol di(meth)acrylate; 1,6-hexanediol di(meth)acrylate; diethylene glycol di(meth)acrylate; triethylene glycol di(meth)acrylate; tetraethylene glycol di(meth)acrylate; ethylenebis[oxy(2-hydroxypropane-1,3-diyl)]di-(meth)acrylate; bis[2-(meth)acryloxyethyl]phosphate; 3,4-bis[(meth)acryloyl]tetrahydrofuan; di(meth)acrylamide; N,N-di(meth)acryloyl-N-methylamine; N,N-di(meth)acryloyl-N-ethylamine; N,N′-methylene bis((meth)acrylamide); N,N′-ethylene bis((meth)acrylamide); N,N′-hexamethylene bis-(meth)acrylamide; N,N′-dihydroxyethylene bis(meth)acrylamide; N,N′-propylene bis-(meth)acrylamide; N,N′-2-hydroxypropylene bis(meth)acrylamide; N,N′-2,3-dihydroxy-butylene bis(meth)acrylamide; 1,3-bis(meth)acrylamidepropane-2-yl dihydrogen phosphate; piperazine diacrylamide; pentaerythritol tri(meth)acrylate; trimethyloylpropane tri(meth)acrylate; tris(2-hydroxyethyl)isocyanurate tri(meth)acrylate; 1,3,5-tri(meth)acryloxyl-hexahydro-1,3,5-triazine; pentaerythritol tetra(meth)acrylate; di(trimethyloylpropane)tetra(meth)acrylate; tetraethyleneglycol divinyl ether, triethyleneglycol divinyl ether, diethyleneglycol divinyl ether, ethyleneglycol divinyl ether, triallyl isocyanurate, triallyl cyanurate, allylmethacrylate, allylacrylate, N-allyl-methacrylamide, N-allyl-acrylamide, or combinations thereof.

In accordance with the invention, a silicone-containing vinylic monomer can be any silicone-containing vinylic monomer known to a person skilled in the art. Examples of preferred silicone-containing vinylic monomers include without limitation vinylic monomers each having a bis(trialkylsilyloxy)alkylsilyl group or a tris(trialkylsilyloxy)silyl group, polysiloxane vinylic monomers, 3-methacryloxy propylpentamethyldisiloxane, t-butyldimethyl-siloxyethyl vinyl carbonate, trimethylsilylethyl vinyl carbonate, and trimethylsilylmethyl vinyl carbonate, and combinations thereof.

Preferred polysiloxanes vinylic monomers can be obtained from commercial suppliers (e.g., Shin-Etsu, Gelest, etc.); prepared according to procedures described in patents, e.g., U.S. Pat. Nos. 5,070,215, 6,166,236, 6,867,245, 8,415,405, 8,475,529, 8,614,261, and 9,217,813; prepared by reacting a hydroxyalkyl (meth)acrylate or (meth)acrylamide or a (meth)acryloxy-polyethylene glycol with a mono-epoxypropyloxypropyl-terminated polydimethylsiloxane; prepared by reacting glycidyl (meth)acrylate with a mono-carbinol-terminated polydimethylsiloxane, a mono-aminopropyl-terminated polydimethylsiloxane, or a mono-ethylaminopropyl-terminated polydimethylsiloxane; or prepared by reacting isocyanatoethyl (meth)acrylate with a mono-carbinol-terminated polydimethylsiloxane according to coupling reactions well known to a person skilled in the art.

Preferred silicone-containing vinylic monomers each having a bis(trialkylsilyloxy)-alkylsilyl group or a tris(trialkylsilyloxy)silyl group can be prepared according to procedures described in U.S. Pat. Nos. 5,070,215, 6,166,236, 7,214,809, 8,475,529, 8,658,748, 9,097,840, 9,103,965, and 9,475,827.

Any suitable polysiloxane vinylic crosslinkers can be used in the invention. Examples of preferred polysiloxane vinylic crosslinkers are di-(meth)acryloyl-terminated polydimethylsiloxanes; di-vinyl carbonate-terminated polydimethylsiloxanes; di-vinyl carbamate-terminated polydimethylsiloxane; N,N,N′,N′-tetrakis(3-methacryloxy-2-hydroxypropyl)-alpha,omega-bis-3-aminopropyl-polydimethylsiloxane; polysiloxane-containing macromer selected from the group consisting of Macromer A, Macromer B, Macromer C, and Macromer D described in U.S. Pat. No. 5,760,100; polysiloxane-containing macromers disclosed in U.S. Pat. Nos. 4,136,250, 4,153,641, 4,182,822, 4,189,546, 4,343,927, 4,254,248, 4,355,147, 4,276,402, 4,327,203, 4,341,889, 4,486,577, 4,543,398, 4,605,712, 4,661,575, 4,684,538, 4,703,097, 4,833,218, 4,837,289, 4,954,586, 4,954,587, 5,010,141, 5,034,461, 5,070,170, 5,079,319, 5,039,761, 5,346,946, 5,358,995, 5,387,632, 5,416,132, 5,451,617, 5,486,579, 5,962,548, 5,981,675, 6,039,913, and 6,762,264; polysiloxane-containing macromers disclosed in U.S. Pat. Nos. 4,259,467, 4,260,725, and 4,261,875.

One class of preferred polysiloxane vinylic crosslinkers are di-(meth)acryloyloxy-terminated polysiloxane vinylic crosslinkers each having dimethylsiloxane units and hydrophilized siloxane units each having one methyl substituent and one monovalent C₄-C₄₀ organic radical substituent having 2 to 6 hydroxyl groups, which can be prepared according to the procedures disclosed in U.S. Pat. No. 10,081,697.

Another class of preferred polysiloxane vinylic crosslinkers are vinylic crosslinkers each of which comprises one sole polydiorganosiloxane segment and two terminal (meth)acryloyl groups, which can be obtained from commercial suppliers; prepared by reacting glycidyl (meth)acrylate (meth)acryloyl chloride with a di-amino-terminated polydimethylsiloxane or a di-hydroxyl-terminated polydimethylsiloxane; prepared by reacting isocyantoethyl (meth)acrylate with di-hydroxyl-terminated polydimethylsiloxanes prepared by reacting an amino-containing vinylic monomer with di-carboxyl-terminated polydimethylsiloxane in the presence of a coupling agent (a carbodiimide); prepared by reacting a carboxyl-containing vinylic monomer with di-amino-terminated polydimethylsiloxane in the presence of a coupling agent (a carbodiimide); or prepared by reacting a hydroxyl-containing vinylic monomer with a di-hydroxy-terminated polydisiloxane in the presence of a diisocyanate or di-epoxy coupling agent.

Other classes of preferred polysiloxane vinylic crosslinkers are chain-extended polysiloxane vinylic crosslinkers each of which has at least two polydiorganosiloxane segments linked by a linker between each pair of polydiorganosiloxane segments and two terminal ethylenically unsaturated groups, which can be prepared according to the procedures described in U.S. Pat. Nos. 5,034,461, 5,416,132, 5,449,729, 5,760,100, 7,423,074, 8,529,057, 8,835,525, 8,993,651, 10,301,451, and 10,465,047.

Examples of aryl vinylic monomers include, but are not limited to: 2-ethylphenoxy acrylate; 2-ethylphenoxy methacrylate; phenyl (meth)acrylate; benzyl (meth)acrylate; 2-phenylethyl (meth)acrylate; 3-phenylpropyl (meth)acrylate; 4-phenylbutyl (meth)acrylate; 4-methylphenyl (meth)acrylate; 4-methylbenzyl (meth)acrylate; 2-(2-methylphenyl)ethyl (meth)acrylate; 2-(3-methylphenyl)ethyl (meth)acrylate; 2-(4-methylphenyl)-ethyl (meth)acrylate; 2-(4-propylphenyl)ethyl (meth)acrylate; 2-(4-(1-methylethyl)phenyl)ethyl (meth)acrylate; 2-(4-methoxyphenyl)ethyl (meth)acrylate; 2-(4-cyclohexylphenyl)ethyl (meth)acrylate; 2-(2-chlorophenyl)ethyl (meth)acrylate; 2-(3-chlorophenyl)ethyl (meth)acrylate; 2-(4-chlorophenyl)ethyl (meth)acrylate; 2-(4-bromophenyl)ethyl (meth)acrylate; 2-(3-phenylphenyl)ethyl (meth)acrylate; 2-(4-phenylphenyl)ethyl (meth)acrylate; 2-(4-benzylphenyl)ethyl (meth)acrylate; 2-(phenylthio)ethyl (meth)acrylate; 2-benzyloxyethyl (meth)acrylate; 3-benzyloxypropyl (meth)acrylate; 2-[2-(benzyloxy)ethoxy]-ethyl (meth)acrylate; p-vinylphenyltris(trimethylsiloxy)silane; m-vinylphenyltris(trimethylsiloxy)silane; o-vinylphenyltris(trimethylsiloxy)silane; p-styrylethyltris(trimethylsiloxy)silane; m-styrylethyl-tris(trimethylsiloxy)silane; o-styrylethyltris(trimethylsiloxy)silane; vinyl naphthalenes; vinyl anthracenes; vinyl phenanthrenes; vinyl pyrenes; vinyl biphenyls; vinyl terphenyls; vinyl phenyl naphthalenes; vinyl phenyl anthracenes; vinyl phenyl phenanthrenes; vinyl phenyl pyrenes; vinyl phenyl terphenyls; phenoxy styrenes; phenyl carbonyl styrenes; phenyl carboxy styrenes; phenoxy carbonyl styrenes; allyl naphthalenes; allyl anthracenes; allyl phenanthrenes; allyl pyrenes; allyl biphenyls; allyl terphenyls; allyl phenyl naphthalenes; allyl phenyl anthracenes, allyl phenyl phenanthrenes; allyl phenyl pyrenes; allyl phenyl terphenyls; allyl phenoxy benzenes; allyl(phenylcarbonyl)benzenes; allyl phenoxy benzenes; allyl(phenyl carbonyl)benzenes; allyl(phenylcarboxy)benzenes; allyl(phenoxy carbonyl)benzenes; styrene; 2,5-dimethylstyrene; 2-(trifluoromethyl) styrene; 2-chlorostyrene; 3,4-dimethoxystyrene; 3-chlorostyrene; 3-bromostyrene; 3-vinylanisole; 3-methylstyrene; 4-bromostyrene; 4-tert-butylstyrene; 2,3,4,5,6-pentanfluorostyrene; 2,4-dimethylstyrene; 1-methoxy-4-vinylbenzene; 1-chloro-4-vinylbenzene; 1-methyl-4-vinylbenzene; 1-(chloromethyl)-4-vinylbenzene; 1-(bromomethyl)-4-vinylbenzene; 3-nitrostyrene; 1,2-vinyl phenyl benzene; 1,3-vinyl phenyl benzene; 1,4-vinyl phenyl benzene; 4-vinyl-1,1′-(4′-phenyl) biphenylene; 1-vinyl-4-(phenyloxy)benzene; 1-vinyl-3-(phenyloxy)-benzene; 1-vinyl-2-(phenyloxy)benzene; 1-vinyl-4-(phenyl carbonyl)benzene; 1-vinyl-3-(phenylcarboxy)benzene; 1-vinyl-2-(phenoxycarbonyl)benzene; allyl phenyl ether; 2-biphenylylallyl ether; allyl 4-phenoxyphenyl ether; allyl 2,4,6-tribromophenyl ether; allyl phenyl carbonate; 1-allyloxy-2-trifluoromethylbenzene; allylbenzene; 1-phenyl-2-prop-2-enylbenzene; 4-phenyl-1-butene; 4-phenyl-1-butene-4-ol; 1-(4-methylphenyl)-3-buten-1-ol; 1-(4-chlorophenyl)-3-buten-1-ol, 4-allyltoluene; 1-allyl-4-fluorobenzene; 1-allyl-2-methyl-benzene; 1-allyl-3-methylbenzene; 1-allyl-3-methylbenzene; 2-allylanisole; 4-allylanisole; 1-allyl-4-(trifluromethyl)benzene; allylpentafluorobenzene; 1-allyl-2-methoxybenzene; 4-allyl-1,2-dimethoxybenzene; 2-allylphenol; 2-allyl-6-methylphenol; 4-allyl-2-methoxyphenol; 2-allyloxyanisole; 4-allyl-2-methoxyphenyl acetate; 2-allyl-6-methoxyphenol; 1-allyl-2-bromobezene; alpha-vinylbenzyl alcohol; 1-phenyl-3-butene-1-one; allylbenzyl ether; (3-allyloxy)propyl)benzene; allyl phenylethyl ether; 1-benzyloxy-4-pentene; (1-allyloxy)ethyl)-benzene; 1-phenylallyl ethyl ether; (2-methyl-2-(2-propenyloxy)propyl)benzene; ((5-hexenyloxy)methyl)benzene; 1-allyloxy-4-propoxybenzene; 1-phenoxy-4-(3-prop-2-enoxypropoxy)benzene; 6-(4′-Hydroxyphenoxy)-1-Hexene; 4-but-3-enoxyphenol; 1-allyloxy-4-butoxybenzene; 1-allyloxy-4-ethoxybenzene; 1-allyl-4-benzyloxybenzene; 1-allyl-4-(phenoxy)benzene; 1-allyl-3-(phenoxy)benzene; 1-allyl-2-(phenoxy)benzene; 1-allyl-4-(phenyl carbonyl)benzene; 1-allyl-3-(phenyl carboxy)benzene; 1-allyl-2-(phenoxycarbonyl)-benzene; 1,2-allyl phenyl benzene; 1,3-allyl phenyl benzene; 1,4-allyl phenyl benzene; 4-vinyl-1,1′-(4′-phenyl) biphenylene; 1-allyl-4-(phenyloxy)benzene; 1-allyl-3-(phenyloxy)-benzene; 1-allyl-2-(phenyloxy)benzene; 1-allyl-4-(phenyl carbonyl)benzene; 1-allyl-3-(phenyl carboxy)benzene; 1-allyl-2-(phenoxycarbonyl)benzene; 1-vinyl naphthylene; 2-vinyl naphthylene; 1-allyl naphthalene; 2-allyl naphthalene; allyl-2-naphthyl ether; 2-(2-methylprop-2-enyl) naphthalene; 2-prop-2-enylnaphthalene; 4-(2-naphthyl)-1-butene; 1-(3-butenyl) naphthalene; 1-allyl naphthalene; 2-allyl naphthalene; 1-allyl-4-napthyl naphthalene; 2-(allyloxy)-1-bromonaphthalene; 2-bromo-6-allyloxynaphthalene; 1,2-vinyl(1-naphthyl)-benzene; 1,2-vinyl(2-naphthyl)benzene; 1,3-vinyl(1-naphthyl)benzene; 1,3-vinyl(2-naphthyl)-benzene; 1,4-vinyl(1-naphthyl)benzene; 1,4-vinyl(2-naphthyl)benzene; 1-naphthyl-4-vinyl naphthalene; 1-allyl naphthalene; 2-allyl naphthalene; 1,2-allyl(1-naphthyl)benzene; 1,2-allyl(2-naphthyl)benzene; 1,3-allyl(1-naphthyl)benzene; 1,3-allyl(2-naphthyl)benzene; 1,4-allyl(1-naphthyl)benzene; 1,4-allyl(2-naphthyl)benzene; 1-allyl-4-napthyl naphthalene; 1-vinyl anthracene; 2-vinyl anthracene; 9-vinyl anthracene; 1-allyl anthracene; 2-allyl anthracene; 9-allyl anthracene; 9-pent-4-enylanthracene; 9-allyl-1,2,3,4-tetrachloroanthracene; 1-vinyl phenanthrene; 2-vinyl phenanthrene; 3-vinyl phenanthrene; 4-vinyl phenanthrene; 9-vinyl phenanthrene; 1-allyl phenanthrene; 2-allyl phenanthrene; 3-allyl phenanthrene; 4-allyl phenanthrene; 9-allyl phenanthrene; and combinations thereof.

Preferred aryl vinylic monomers are 2-phenylethyl acrylate; 3-phenylpropyl acrylate; 4-phenylbutyl acrylate; 5-phenylpentyl (meth)acrylate; 2-benzyloxyethyl (meth)acrylate; 3-benzyloxypropyl (meth)acrylate; 2-[2-(benzyloxy)ethoxy]ethyl (meth)acrylate; p-vinylphenyl-tris(trimethylsiloxy)silane; m-vinylphenyltris(trimethylsiloxy)silane; o-vinylphenyl-tris(trimethyl-siloxy)silane; p-styrylethyltris(trimethylsiloxy)silane; m-styrylethyl-tris(trimethylsiloxy)silane; o-styrylethyltris(trimethylsiloxy)silane; or combinations thereof. Most preferred are p-vinylphenyltris(trimethylsiloxy)silane; m-vinylphenyltris(trimethylsiloxy)silane; o-vinylphenyl-tris(trimethylsiloxy)silane; p-styrylethyltris(trimethylsiloxy)silane; m-styrylethyl-tris(trimethyl-siloxy)silane; o-styrylethyltris(trimethylsiloxy)silane; or combinations thereof.

Any aryl vinylic crosslinkers can be used. Examples of aryl vinylic crosslinkers include without limitation non-silicone aryl vinylic crosslinkers (e.g., divinylbenzene, 2-methyl-1,4-divinylbenzene, bis(4-vinylphenyl) methane, 1,2-bis(4-vinylphenyl) ethane, etc.), silicone-containing aryl vinylic crosslinkers.

Preferred silicone-containing aryl vinylic crosslinkers are aryl-containing polysiloxane vinylic crosslinkers each of which comprises: (1) a polysiloxane segment comprising dimethylsiloxane units and aryl-containing siloxane units each having at least one aryl-containing substituent having up to 45 carbon atoms; and (2)ethylenically-unsaturated groups (preferably (meth)acryloyl groups). In a preferred embodiment, the polysiloxane segment comprises at least 25% by mole of the aryl-containing siloxane units. The preferred aryl-containing polysiloxane vinylic crosslinkers can have a number average molecular weight of at least 1000 Daltons (preferably from 1500 Daltons to 100000 Daltons, more preferably from 2000 to 80000 Daltons, even more preferably from 2500 to 60000 Dalton).

Examples of such preferred aryl-containing polysiloxane vinylic crosslinkers include without limitation vinyl terminated polyphenylmethysiloxanes (e.g., PMV9925 from Gelest), vinylphenylmethyl terminated phenylmethyl-vinylphenylsiloxane copolymer (e.g., PVV-3522 from Gelest), vinyl terminated diphenylsiloxane-dimethylsiloxane copolymers (e.g., PDV-1625 from Gelest), (meth)acryloxyalkyl-terminated polyphenylmethysiloxanes, (meth)acryloxyalkyl-terminated phenylmethyl-vinylphenylsiloxane copolymers, (meth)acryloxyalkyl-terminated diphenylsiloxane-dimethylsiloxane copolymers, ethylenically-unsaturated group-terminated dimethylsiloxane-arylmethylsiloxane copolymers disclosed in U.S. Pat. Appl. Pub. No. 2022/00306810, or combinations thereof.

Any suitable UV-absorbing vinylic monomers and UV/HEVL-absorbing vinylic monomers can be used in a polymerizable composition for preparing a preformed SiHy contact lens of the invention. Examples of preferred UV-absorbing and UV/HEVL-absorbing vinylic monomers include without limitation: 2-(2-hydroxy-5-vinylphenyl)-2H-benzotriazole, 2-(2-hydroxy-5-acrylyloxyphenyl)-2H-benzotriazole, 2-(2-hydroxy-3-methacrylamido methyl-5-tert octylphenyl)benzotriazole, 2-(2′-hydroxy-5′-methacrylamidophenyl)-5-chlorobenzo-triazole, 2-(2′-hydroxy-5′-methacrylamidophenyl)-5-methoxybenzotriazole, 2-(2′-hydroxy-5′-methacryloxypropyl-3′-t-butyl-phenyl)-5-chlorobenzotriazole, 2-(2′-hydroxy-5′-methacryloxy-propylphenyl)benzotriazole, 2-hydroxy-5-methoxy-3-(5-(trifluoromethyl)-2H-benzo[d][1,2,3]-triazol-2-yl)benzyl methacrylate (WL-1), 2-hydroxy-5-methoxy-3-(5-methoxy-2H-benzo[d]-[1,2,3]triazol-2-yl)benzyl methacrylate (WL-5), 3-(5-fluoro-2H-benzo[d][1,2,3]triazol-2-yl)-2-hydroxy-5-methoxybenzyl methacrylate (WL-2), 3-(2H-benzo[d][1,2,3]triazol-2-yl)-2-hydroxy-5-methoxybenzyl methacrylate (WL-3), 3-(5-chloro-2H-benzo[d][1,2,3]triazol-2-yl)-2-hydroxy-5-methoxybenzyl methacrylate (WL-4), 2-hydroxy-5-methoxy-3-(5-methyl-2H-benzo[d]-[1,2,3]triazol-2-yl)benzyl methacrylate (WL-6), 2-hydroxy-5-methyl-3-(5-(trifluoromethyl)-2H-benzo[d][1,2,3]triazol-2-yl)benzyl methacrylate (WL-7), 4-allyl-2-(5-chloro-2H-benzo[d][1,2,3]-triazol-2-yl)-6-methoxyphenol (WL-8), 2-{2′-Hydroxy-3′-tert-5′[3″-(4″-vinylbenzyloxy)propoxy]-phenyl}-5-methoxy-2H-benzotriazole, phenol, 2-(5-chloro-2H-benzotriazol-2-yl)-6-(1,1-dimethylethyl)-4-ethenyl-(UVAM), 2-[2′-hydroxy-5′-(2-methacryloxyethyl)phenyl)]-2H-benzotriazole (2-Propenoic acid, 2-methyl-, 2-[3-(2H-benzotriazol-2-yl)-4-hydroxyphenyl]-ethyl ester, Norbloc), 2-{2′-Hydroxy-3′-tert-butyl-5′-[3′-methacryloyloxypropoxy]phenyl}-2H-benzotriazole, 2-{2′-Hydroxy-3′-tert-butyl-5′-[3′-methacryloyloxypropoxy]phenyl}-5-methoxy-2H-benzotriazole (UV13), 2-{2′-Hydroxy-3′-tert-butyl-5′-[3′-methacryloyloxypropoxy]phenyl}-5-chloro-2H-benzotriazole (UV28), 2-[2′-Hydroxy-3′-tert-butyl-5′-(3′-acryloyloxypropoxy)-phenyl]-5-trifluoromethyl-2H-benzotriazole (UV23), 2-(2′-hydroxy-5-methacrylamidophenyl)-5-methoxybenzotriazole (UV6), 2-(3-allyl-2-hydroxy-5-methylphenyl)-2H-benzotriazole (UV9), 2-(2-Hydroxy-3-methallyl-5-methylphenyl)-2H-benzotriazole (UV12), 2-3′-t-butyl-2′-hydroxy-5′-(3″-dimethylvinylsilylpropoxy)-2′-hydroxy-phenyl)-5-methoxybenzotriazole (UV15), 2-(2′-hydroxy-5′-methacryloylpropyl-3′-tert-butyl-phenyl)-5-methoxy-2H-benzotriazole (UV16), 2-(2′-hydroxy-5′-acryloylpropyl-3′-tert-butyl-phenyl)-5-methoxy-2H-benzotriazole (UV16A), 2-Methylacrylic acid 3-[3-tert-butyl-5-(5-chlorobenzotriazol-2-yl)-4-hydroxyphenyl]-propyl ester (16-100, CAS #96478-15-8), 2-(3-(tert-butyl)-4-hydroxy-5-(5-methoxy-2H-benzo[d][1,2,3]-triazol-2-yl) phenoxy)ethyl methacrylate (16-102); Phenol, 2-(5-chloro-2H-benzotriazol-2-yl)-6-methoxy-4-(2-propen-1-yl) (CAS #1260141-20-5); 2-[2-Hydroxy-5-[3-(methacryloyloxy)-propyl]-3-tert-butylphenyl]-5-chloro-2H-benzotriazole; Phenol, 2-(5-ethenyl-2H-benzotriazol-2-yl)-4-methyl-, homopolymer (9CI) (CAS #83063-87-0). In accordance with the invention, the polymerizable composition comprises about 0.1% to about 3.0%, preferably about 0.2% to about 2.5%, more preferably about 0.3% to about 2.0%, by weight of one or more UV-absorbing vinylic monomers, related to the amount of all polymerizable components in the polymerizable composition.

Any thermal polymerization initiators can be used in the invention. Suitable thermal polymerization initiators are known to the skilled artisan and comprise, for example peroxides, hydroperoxides, azo-bis(alkyl- or cycloalkylnitriles), persulfates, percarbonates, or mixtures thereof. Examples of preferred thermal polymerization initiators include without limitation benzoyl peroxide, t-butyl peroxide, t-amyl peroxybenzoate, 2,2-bis(tert-butyl-peroxy)butane, 1,1-bis(tert-butylperoxy)cyclohexane, 2,5-Bis(tert-butylperoxy)-2,5-dimethyl-hexane, 2,5-bis(tert-butylperoxy)-2,5-dimethyl-3-hexyne, bis(1-(tert-butylperoxy)-1-methylethyl)benzene, 1,1-bis(tert-butylperoxy)-3,3,5-trimethylcyclohexane, di-t-butyl-diperoxyphthalate, t-butyl hydro-peroxide, t-butyl peracetate, t-butyl peroxybenzoate, t-butylperoxy isopropyl carbonate, acetyl peroxide, lauroyl peroxide, decanoyl peroxide, dicetyl peroxydicarbonate, di(4-t-butylcyclohexyl)peroxy dicarbonate (Perkadox 16S), di(2-ethylhexyl)peroxy dicarbonate, t-butylperoxy pivalate (Lupersol 11); t-butylperoxy-2-ethylhexanoate (Trigonox 21-C50), 2,4-pentanedione peroxide, dicumyl peroxide, peracetic acid, potassium persulfate, sodium persulfate, ammonium persulfate, 2,2′-azobis(4-methoxy-2,4-dimethylvaleronitrile) (VAZO 33), 2,2′-Azobis[2-(2-imidazolin-2-yl) propane]-dihydrochloride (VAZO 44), 2,2′-azobis(2-amidinopropane) dihydrochloride (VAZO 50), 2,2′-azobis(2,4-dimethylvaleronitrile) (VAZO 52), 2,2′-azobis(isobutyronitrile) (VAZO 64 or AIBN), 2,2′-azobis-2-methylbutyronitrile (VAZO 67), 1,1-azobis(1-cyclohexanecarbonitrile) (VAZO 88); 2,2′-azobis(2-cyclopropylpropionitrile), 2,2′-azobis(methylisobutyrate), 4,4′-Azobis(4-cyanovaleric acid), and combinations thereof. Preferably, the thermal initiator is 2,2′-azobis(isobutyronitrile) (AIBN or VAZO 64).

Suitable photoinitiators are benzoin methyl ether, diethoxyacetophenone, a benzoylphosphine oxide, 1-hydroxycyclohexyl phenyl ketone and Darocur and Irgacur types, preferably Darocur 1173® and Darocur 2959®, acyl Germanium photoinitiators (e.g., those described in U.S. Pat. No. 7,605,190). Examples of benzoylphosphine initiators include 2,4,6-trimethylbenzoyldiphenylophosphine oxide; bis-(2,6-dichlorobenzoyl)-4-N-propylphenyl-phosphine oxide; and bis-(2,6-dichlorobenzoyl)-4-N-butylphenylphosphine oxide.

An embedded contact lens of the invention can have various structural configuration.

In a first preferred structural configuration, the convex surface of the insert merges with the anterior surface of the lens body whereas the concave surface of the insert is buried beneath the posterior surface of the lend body. In accordance with this structural configuration, the curvature of the convex surface of the insert is identical to the curvature of a central zone of the anterior surface, wherein the central zone has a diameter of the insert. Preferably, the insert comprises a diffractive optics on the concave surface of the insert.

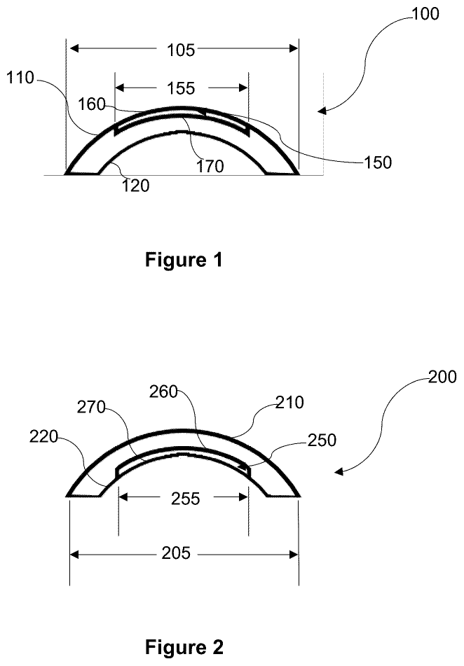

FIG. 1 schematically illustrates a cross-sectional view of an embedded hydrogel contact lens having the first preferred structural configuration. The lens body 100 of an embedded hydrogel contact lens comprises an anterior surface 110, an opposite posterior surface 120, and an insert 150 and has a diameter 105 of from about 12.5 mm to about 15.5 mm. The insert 150 is made of a hydrogel material different from the hydrogel material of the remaining part of the lens body 100 and comprises a convex surface 160 and an opposite concave surface 170. The insert 150 has a diameter 155 of from about 5.0 mm to about 11.5 mm and sufficient small so as to be located within the optical zone of the lens body 100 of the embedded hydrogel contact lens. According to this preferred embodiment, the convex surface 160 of the insert 150 has a curvature substantially identical to the curvature of the central zone of the anterior surface 110 of the embedded hydrogel contact lens, and merges with the anterior surface 110 of the lens body 100 of the embedded hydrogel contact lens.

An embedded contact lens with the first preferred structural configuration can be obtained according to methods disclosed in U.S. Pat. No. 2022/0324187 A1.

As an illustrative example, such an embedded contact lens can be obtained according to the following procedures: (1) obtaining a female mold half, a first male mold half and a second male mold half, wherein the female mold half has a first molding surface defining the anterior surface of a contact lens to be molded, wherein the first male mold half has a second molding surface defining the back surface of an insert to be molded, wherein the second male mold half has a third molding surface defining the posterior surface of the contact lens to be molded, wherein the first male mold half and the female mold half are configured to receive each other such that an insert-molding cavity is formed between the second molding surface and a central portion of the first molding surface when the female mold half is closed with the first male mold half, wherein the second male mold half and the female mold half are configured to receive each other such that a lens-molding cavity is formed between the first and third molding surfaces when the female mold half is closed with the second male mold half; (2) obtaining a first polymerizable composition (any one of those disrobed in this application for forming a first hydrogel material of the invention) and a second polymerizable composition (any one of those described in this application for forming a composite material of the invention); (3) dispensing an amount of the second polymerizable composition on the central portion of the first molding surface of the female mold half; (4) placing the first male mold half on top of the second polymerizable composition in the female mold half and closing the first male mold half and the female mold half to form a first molding assembly comprising the second polymerizable composition within the insert-molding cavity; (5) curing the second polymerizable composition in the insert-molding cavity of the first molding assembly to form a molded insert that is made of a composite material formed from the second polymerizable composition and comprises a second hydrogel material and nanoparticles distributed in the polymer matrix of the second hydrogel material; (6) separating the first molding assembly obtained in step (5) into the first male mold half and the female mold half with the molded insert that is adhered onto the central area of the first molding surface; (7) dispensing the first polymerizable composition in the female mold half with the molded insert adhered thereon in an amount sufficient for filling the lens-molding cavity; (8) placing the second male mold half on top of the first polymerizable composition in the female mold half and closing the second male mold half and the female mold half to form a second molding assembly comprising the first polymerizable composition and the molded insert immersed therein in the lens-molding cavity; (9) curing the first polymerizable composition in the lens-molding cavity of the second molding assembly to form an embedded contact lens precursor that comprises a first hydrogel material formed from the first polymerizable composition and the insert embedded in the first hydrogel material; (10) separating the second molding assembly obtained in step (9) into the second male mold half and the female mold half, with the embedded contact lens precursor adhered on a lens-adhered mold half which is one of the female and second male mold halves; (11) removing the embedded contact lens precursor obtained in step (10) from the lens-adhered mold half; and (12) subjecting the embedded contact lens precursor to post-molding processes including a hydration process and one or more other processes selected from the group consisting of extraction, surface treatment, packaging, sterilization, and combinations thereof, to obtain an embedded contact lens of the invention.

In a second preferred structural configuration, the concave surface of the insert merges with the posterior surface of the lens body whereas the convex surface of the insert is buried beneath the anterior surface of the lens body. In accordance with this preferred structural configuration, the curvature of the concave surface of the insert is identical to the curvature of a central zone of the insert of the posterior surface, wherein the central zone has a diameter of the insert. Preferably, the insert comprises a diffractive optics on the convex surface of the insert.

FIG. 2 schematically illustrates a cross-sectional view of an embedded hydrogel contact lens with the second preferred structural configuration. The lens body 200 of an embedded hydrogel contact lens comprises an anterior surface 210, an opposite posterior surface 220, and an insert 250 and has a diameter 205 of from about 12.5 mm to about 15.5 mm. The insert 250 is made of a hydrogel material different from the hydrogel material of the remaining part of the lens body 200 and comprises a convex surface 260 and an opposite concave surface 270. The insert 250 has a diameter 255 of from about 5.0 mm to about 11.5 mm and sufficient small so as to be located within the optical zone of the lens body 200 of the embedded hydrogel contact lens. According to this preferred embodiment, the concave surface 270 of the insert 250 has a curvature identical to the curvature of the central zone of the posterior surface 220 of the lens body 200 of the embedded hydrogel contact lens, and merges with the posterior surface 220 of the lens body 200 of the embedded hydrogel contact lens.

An embedded contact lens having the second preferred structural configuration can be obtained according to methods disclosed in U.S. Pat. No. 2022/0324187 A1.

As an illustrative example, such an embedded contact lens can be obtained according to the following procedures: (1) obtaining a first female mold half, a male mold half and a second female mold half, wherein the first female mold half has a first molding surface defining the front surface of an insert to be molded, wherein the male mold half has a second molding surface defining the posterior surface of a contact lens to be molded, wherein the second female mold half has a third molding surface defining the anterior surface of the contact lens to be molded, wherein the first female mold half and the male mold half are configured to receive each other such that an insert-molding cavity is formed between the first molding surface and a central portion of the second molding surface when the first female mold half is closed with the male mold half, wherein the second female mold half and the male mold half are configured to receive each other such that a lens-molding cavity is formed between the second and third molding surfaces when the second female mold half is closed with the male mold half; (2) obtaining a first polymerizable composition (any one of those disrobed in this application for forming a first hydrogel material of the invention) and a second polymerizable composition (any one of those described in this application for forming a composite material of the invention); (3) dispensing an amount of the second polymerizable composition on the first molding surface of the first female mold half; (4) placing the male mold half on top of the second polymerizable composition in the first female mold half and closing the first female mold half and the male mold half to form a first molding assembly comprising the second polymerizable composition within the insert-molding cavity; (5) curing the second polymerizable composition in the insert-molding cavity of the first molding assembly to form a molded insert that is made of a composite material formed from the second polymerizable composition and comprises a second hydrogel material and nanoparticles distributed in the polymer matrix of the second hydrogel material; (6) separating the first molding assembly obtained in step (5) into the first female mold half and the male mold half with the molded insert that is adhered onto the central portion of the second molding surface; (7) dispensing the first polymerizable composition in the second female mold half in an amount sufficient for filling the lens-molding cavity; (8) placing the male mold half with the molded insert adhered thereon on top of the first polymerizable composition in the second female mold half and closing the second female mold half and the male mold half to form a second molding assembly comprising the first polymerizable composition and the molded insert immersed therein in the lens-molding cavity; (9) curing the first polymerizable composition in the lens-molding cavity of the second molding assembly to form an embedded contact lens precursor that comprises a first hydrogel material formed from the first polymerizable composition and the insert completely or partially embedded in the first hydrogel material; (10) separating the second molding assembly obtained in step (9) into the second female mold half and the male mold half, with the embedded contact lens precursor adhered on a lens-adhered mold half which is one of the male and second female mold halves; (11) removing the embedded contact lens precursor obtained in step (10) from the lens-adhered mold half; and (12) subjecting the embedded contact lens precursor to post-molding processes including a hydration process and one or more other processes selected from the group consisting of extraction, surface treatment, packaging, sterilization, and combinations thereof to obtain an embedded contact lens of the invention.

In a third preferred structural configuration, the convex surface of the insert is buried beneath the anterior surface of the lens body at a first depth whereas the concave surface of the insert is buried beneath the posterior surface of the lens body at a second depth, wherein the first depth and the second depth independent of each other are 10 microns or larger. Preferably, the insert comprises a diffractive optics on the convex or concave surface of the insert.

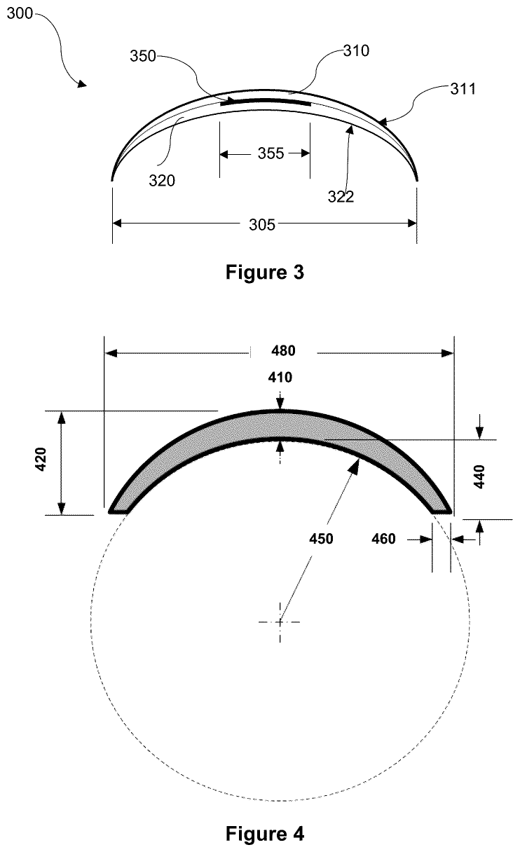

FIG. 3 illustrates an embedded hydrogel contact lens according to this preferred embodiment of the invention. An embedded hydrogel contact lens has a lens body 300 that has an anterior surface 311, an opposite posterior surface 322, and a diameter 305 of from about 12.5 mm to about 15.5 mm. The lens body 300 comprises an insert 350 sandwiched between the anterior layer 310 of a first hydrogel material and the posterior layer 320 of the first hydrogel material. The anterior layer 310 includes the anterior surface 311, and the posterior layer 320 includes the posterior surface 322. The insert 350 has a convex surface, an opposite concave surface, and a diameter 355 of from about 5.0 mm to about 11.5 mm.

An embedded contact lens with the third preferred structural configuration can be obtained according to methods disclosed in U.S. Pat. No. 2022/0326412 A1.

As an illustrative example, such an embedded contact lens can be obtained according to the following procedures: (1) obtaining a first female mold half, a first male mold half, a second female mold half, and a second male mold half, wherein the first female mold half has a first molding surface having a central portion defining the front surface of a to-be-molded insert, wherein the first male mold half has a second molding surface defining the back surface of the to-be-molded insert, wherein the second female mold half has a third molding surface defining the anterior surface of an embedded hydrogel contact lens, wherein the second male mold half has a fourth molding surface defining the posterior surface of the embedded hydrogel contact lens, wherein the first female mold half and the first male mold half are configured to receive each other such that a first molding cavity is formed between the central portion of the first molding surface and the second molding surfaces when the first female and first male mold halves are closed securely, wherein the first female mold half and the second male mold half are configured to receive each other such that a second molding cavity is formed between the first and fourth molding surfaces when the first female mold half is closed with the second male mold half, wherein the second female mold half and the second male mold half are configured to receive each other such that a third molding cavity is formed between the third and fourth molding surfaces when the second female mold half is closed securely with the second male mold half; (2) obtaining a first polymerizable composition (any one of those disrobed in this application for forming a first hydrogel material of the invention) and a second polymerizable composition (any one of those described in this application for forming a composite material of the invention); (3) dispensing an amount of the second polymerizable composition on the central portion of the first molding surface of the first female mold half; (4) placing the first male mold half on top of the second polymerizable composition in the first female mold half and closing the first male mold half and the first female mold half to form a first molding assembly comprising the second polymerizable composition therein; (5) curing the second polymerizable composition in the first molding assembly to form a molded insert that has the front surface defined by the central portion of the first molding surface and the back surface defined by the second molding surface and that is made of a composite material formed from the second polymerizable composition and comprises a second hydrogel material and nanoparticles distributed in the polymer matrix of the second hydrogel material; (6) separating the first molding assembly obtained in step 5) into the first male mold half and the first female mold half with the molded insert adhered onto the central portion of the first molding surface of the first female mold half; (7) dispensing an amount of the first polymerizable composition over the molded insert adhered on the central portion of the first molding surface in the first female mold half; (8) placing the second male mold half on top of the first female mold half and closing the second male mold half and the first female mold half to form a second molding assembly comprising the first polymerizable composition and the molded insert immersed therein in the second molding assembly; (9) curing the first polymerizable composition in the second molding assembly to form a lens precursor having a convex surface defined by the first molding surface and an opposite concave surface that is defined by the fourth molding surface and is the posterior surface of the embedded hydrogel contact lens, wherein the lens precursor comprise a first hydrogel material formed from the first lens-forming composition and the insert embedded in the first material in such a way that the front surface of the insert merges with the convex surface of the lens precursor while the back surface of the insert is buried beneath the concave surface of the lens precursor; (10) separating the second molding assembly obtained in step (9) into the second male mold half and the female mold half, with the lens precursor adhered on the second male mold half; (11) dispensing an additional amount of the first polymerizable composition on the third molding surface of the second female mold half; (12) placing the second male mold half obtained in step (10) on top of the second female mold half and closing the second male mold half and the second female mold half to form a third molding assembly comprising the first polymerizable composition and the lens precursor immersed therein in the third molding assembly; (13) curing the first polymerizable composition in the third molding assembly to form an embedded contact lens that comprises the insert sandwiched between two layers of the first hydrogel material formed from the first polymerizable composition; (14) separating the third molding assembly obtained in step (13) into the second male mold half and the second female mold half, with the embedded contact lens adhered on one of the second male mold half and the second female mold half; (15) removing the embedded contact lens from the lens-adhered mold half; and (16) subjecting the embedded contact lens to post-molding processes including a hydration process and one or more other processes selected from the group consisting of extraction, surface treatment, packaging, sterilization, and combinations thereof.

Mold halves for making contact lenses (or inserts) are well known to a person skilled in the art and, for example, are employed in cast molding. In general, a molding assembly comprises at least two mold halves, one male half and one female mold half. The male mold half has a first molding (or optical) surface which is in direct contact with a polymerizable composition for cast molding of a contact lens (or an insert) and defines the posterior (back) surface of a molded contact lens (or a molded insert); and the female mold half has a second molding (or optical) surface which is in direct contact with the polymerizable composition and defines the anterior (front) surface of the molded contact lens (or molded insert). The male and female mold halves are configured to receive each other such that a lens- or insert-forming cavity is formed between the first molding surface and the second molding surface.

In a preferred embodiment, the mold half having a molding surface defining one of the anterior (front) and posterior (back) surfaces of the insert comprise an overflow groove which surrounds the molding surface and receives any excess insert-forming material when the molding assembly is closed. By having such an overflow groove, one can ensure that any flushes formed from the excess insert-forming material during molding of the insert can be stuck on the mold half having a molding surface defining the anterior (front) or posterior (back) surface of the insert during the step of separating the molding assembly halves, thereby removing the flushes.

Methods of manufacturing mold halves for cast-molding a contact lens or an insert are generally well known to those of ordinary skill in the art. The process of the present invention is not limited to any particular method of forming a mold half. In fact, any method of forming a mold half can be used in the present invention. The mold halves can be formed through various techniques, such as injection molding or lathing. Examples of suitable processes for forming the mold halves are disclosed in U.S. Pat. Nos. 4,444,711; 4,460,534; 5,843,346; and 5,894,002.

Virtually all materials known in the art for making mold halves can be used to make mold halves for making contact lenses or inserts. For example, polymeric materials, such as polyethylene, polypropylene, polystyrene, PMMA, Topas® COC grade 8007-S10 (clear amorphous copolymer of ethylene and norbornene, from Ticona GmbH of Frankfurt, Germany and Summit, New Jersey), or the like can be used.

In accordance with the invention, a diffractive structure (i.e., a diffractive optics) is essentially a transmission diffraction grating. As known to a person skilled in the art, a transmission diffraction grating is typically comprised of a plurality of repetitive ridges and/or grooves regularly or periodically spaced and arranged in concentrically rings or zones—annular zones (i.e., echelettes) at a respective surface of a lens (i.e., an insert in this application). The periodic spacing or pitch of the ridges and/or grooves substantially determines the points of destructive and constructive interference at the optical axis of the lens. The shape and height of the ridges and/or grooves control the amount of incident light that is provided at a point of constructive interference by diffraction. The points of constructive interference are generally called diffraction orders or focal points.

The diffractive power is related to the properties of these zones, for instance their number, shape, size and position. Currently used echelettes may typically be defined by a primary zone, a secondary zone between the primary zone and a primary zone of an adjacent echelette, and an echelette geometry. The echelette geometry includes inner and outer diameters and a shaped or sloped profile. Secondary zones may describe the situation where the theoretical primary zone is a discontinuous function, leading to discrete steps in the profile height. Secondary zones may be introduced to solve the manufacturing issue of making sharp corner in a surface, and/or to reduce possible light scatter from sharp corners. The overall profile may be characterized by an echelette height or step height between adjacent echelettes. The relative radial spacing of the echelettes largely determine the power(s) of the lens and the step height of the secondary zones largely determines the light distribution between the different add powers. Together, these echelettes define a diffractive profile, often saw-toothed or stepped, on one of the surfaces of the lens.

The diffractive profile (Z_{diff}) (or so-called sag profile) can be given by Equation 1

$${Z}_{diff} = \frac{m λ φ ( x )}{{RI}_{2} - {RI}_{1}} {x}^{2} \qquad ( 1 )$$

in which m is the diffraction order (typically 0 for the distance focus and 1 for the ADD order), λ is the design wavelength (typically 550 nm), x is radial position (i.e., the radial distance from the center), and φ(x) is a phase function in the radial x direction.

The radial position x of the diffractive transitions is a function of the diffractive optical power to be added to the system or Add power and the wavelength:

$$Zone ( i ) = \sqrt{\frac{2 i λ}{Add}} \qquad ( 2 )$$

And the height of the diffractive transition is given by:

$$Height ( i ) = \vert \frac{m λ}{{RI}_{2} - {RI}_{1}} \vert \qquad ( 3 )$$

It is understood that any phase function known to a person skilled in the art can be used in creating a desired diffractive profile. Exemplary phase functions can be a modulo 2pi kinoform design which would function as a Fresnel lens, an apodized bifocal lens design similar to ReSTOR or a Quadrafocal design similar to PanOptix which would result in a trifocal lens.

The first and second polymerizable compositions can be prepared by mixing all polymerizable components and other necessary component and/or by dissolving all of the desirable components in any suitable non-reactive solvent (i.e., non-reactive diluent), such as, a mixture of water and one or more organic solvents miscible with water, an organic solvent, or a mixture of one or more organic solvents, as known to a person skilled in the art. The term “solvent” refers to a chemical that cannot participate in free-radical polymerization reaction.

Any solvents can be used in the invention. Example of preferred organic solvents includes without limitation, tetrahydrofuran, tripropylene glycol methyl ether, dipropylene glycol methyl ether, ethylene glycol n-butyl ether, ketones (e.g., acetone, methyl ethyl ketone, etc.), diethylene glycol n-butyl ether, diethylene glycol methyl ether, ethylene glycol phenyl ether, propylene glycol methyl ether, propylene glycol methyl ether acetate, dipropylene glycol methyl ether acetate, propylene glycol n-propyl ether, dipropylene glycol n-propyl ether, tripropylene glycol n-butyl ether, propylene glycol n-butyl ether, dipropylene glycol n-butyl ether, tripropylene glycol n-butyl ether, propylene glycol phenyl ether dipropylene glycol dimetyl ether, polyethylene glycols, polypropylene glycols, ethyl acetate, butyl acetate, amyl acetate, methyl lactate, ethyl lactate, i-propyl lactate, methylene chloride, 2-butanol, 1-propanol, 2-propanol, menthol, cyclohexanol, cyclopentanol and exonorborneol, 2-pentanol, 3-pentanol, 2-hexanol, 3-hexanol, 3-methyl-2-butanol, 2-heptanol, 2-octanol, 2-nonanol, 2-decanol, 3-octanol, norborneol, tert-butanol, tert-amyl alcohol, 2-methyl-2-pentanol, 2,3-dimethyl-2-butanol, 3-methyl-3-pentanol, 1-methylcyclohexanol, 2-methyl-2-hexanol, 3,7-dimethyl-3-octanol, 1-chloro-2-methyl-2-propanol, 2-methyl-2-heptanol, 2-methyl-2-octanol, 2-2-methyl-2-nonanol, 2-methyl-2-decanol, 3-methyl-3-hexanol, 3-methyl-3-heptanol, 4-methyl-4-heptanol, 3-methyl-3-octanol, 4-methyl-4-octanol, 3-methyl-3-nonanol, 4-methyl-4-nonanol, 3-methyl-3-octanol, 3-ethyl-3-hexanol, 3-methyl-3-heptanol, 4-ethyl-4-heptanol, 4-propyl-4-heptanol, 4-isopropyl-4-heptanol, 2,4-dimethyl-2-pentanol, 1-methylcyclopentanol, 1-ethylcyclopentanol, 1-ethylcyclopentanol, 3-hydroxy-3-methyl-1-butene, 4-hydroxy-4-methyl-1-cyclopentanol, 2-phenyl-2-propanol, 2-methoxy-2-methyl-2-propanol 2,3,4-trimethyl-3-pentanol, 3,7-dimethyl-3-octanol, 2-phenyl-2-butanol, 2-methyl-1-phenyl-2-propanol and 3-ethyl-3-pentanol, 1-ethoxy-2-propanol, 1-methyl-2-pyrrolidone, N,N-dimethylpropionamide, dimethyl formamide, dimethyl acetamide, dimethyl propionamide, N-methyl pyrrolidinone, and mixtures thereof.

The first polymerizable composition can be a non-silicone hydrogel lens formulation or a silicone hydrogel lens formulation, whereas the second polymerizable composition can be prepared by adding nanoparticles into a a non-silicone hydrogel lens formulation or a silicone hydrogel lens formulation.

Numerous non-silicone hydrogel lens formulations have been described in numerous patents and patent applications published by the filing date of this application and have been used in producing commercial non-silicone hydrogel contact lenses. Examples of commercial non-silicone hydrogel contact lenses include, without limitation, alfafilcon A, acofilcon A, deltafilcon A, etafilcon A, focofilcon A, helfilcon A, helfilcon B, hilafilcon B, hioxifilcon A, hioxifilcon B, hioxifilcon D, methafilcon A, methafilcon B, nelfilcon A, nesofilcon A, ocufilcon A, ocufilcon B, ocufilcon C, ocufilcon D, omafilcon A, phemfilcon A, polymacon, samfilcon A, telfilcon A, tetrafilcon A, and vifilcon A.

Numerous SiHy lens formulations have been described in numerous patents and patent applications published by the filing date of this application and have been used in producing commercial SiHy contact lenses. Examples of commercial SiHy contact lenses include, without limitation, asmofilcon A, balafilcon A, comfilcon A, delefilcon A, efrofilcon A, enfilcon A, fanfilcon A, galyfilcon A, lotrafilcon A, lotrafilcon B, narafilcon A, narafilcon B, senofilcon A, senofilcon B, senofilcon C, smafilcon A, somofilcon A, and stenfilcon A.

After the polymerizable composition is dispensed into the mold, it is polymerized to thermally or actinically, as known to a person skilled in the art.

The thermal polymerization is carried out conveniently, for example at a temperature of from 25 to 120° C. and preferably 40 to 100° C. The reaction time may vary within wide limits, but is conveniently, for example, from 1 to 24 hours or preferably from 2 to 12 hours. It is advantageous to previously degas the components and solvents used in the polymerization reaction and to carry out said copolymerization reaction under an inert atmosphere, for example under a nitrogen or argon atmosphere.

The actinic polymerization can then be triggered off by actinic radiation, for example light, in particular UV light or visible light of a suitable wavelength. The spectral requirements can be controlled accordingly, if appropriate, by addition of suitable photosensitizers.

Opening of the mold so that the molded insert or embedded contact lens can be removed from the mold may take place in a manner known per se.

The molded insert or contact lenses can be subject to lens extraction with a liquid extraction medium to remove unpolymerized polymerizable components and formed and oligomers. In accordance with the invention, the extraction liquid medium is any solvent capable of dissolving the organic solvent, unpolymerized polymerizable materials, and oligomers in the dry contact lens. Water, any organic solvents known to a person skilled in the art, or a mixture thereof can be used in the invention. Preferably, the organic solvents used extraction liquid medium are water, a buffered saline, a C₁-C₃ alkyl alcohol, 1,2-propylene glycol, a polyethyleneglycol having a number average molecular weight of about 400 Daltons or less, a C₁-C₆ alkylalcohol, or combinations thereof.

After extraction, embedded contact lens can be hydrated in water or an aqueous solution to replace the liquid extraction medium, according to any method known to a person skilled in the art.

The hydrated embedded contact lens can further subject to further processes, such as, for example, surface treatment, packaging in lens packages with a packaging solution which is well known to a person skilled in the art; sterilization such as autoclave at from 118 to 124° C. for at least about 30 minutes; and the like.

Lens packages (or containers) are well known to a person skilled in the art for autoclaving and storing a soft contact lens. Any lens packages can be used in the invention. Preferably, a lens package is a blister package which comprises a base and a cover, wherein the cover is detachably sealed to the base, wherein the base includes a cavity for receiving a sterile packaging solution and the contact lens.

Lenses are packaged in individual packages, sealed, and sterilized (e.g., by autoclave at about 120° C. or higher for at least 30 minutes under pressure) prior to dispensing to users. A person skilled in the art will understand well how to seal and sterilize lens packages.

In another aspect, the invention provides an hydrogel ophthalmic device that is a contact lens or an insert, wherein the hydrogel ophthalmic device is made of a composite material composed of a hydrogel material and nanoparticles distributed in the polymer matrix of the hydrogel material, wherein the nanoparticles are nanocrystals of titanium dioxide or zirconia dioxide and are surface-functionalized to contain reactive or non-reactive functional groups thereon, wherein the composite material in fully hydrated state has a refractive index of at least 1.44 and a visible light transmittance of 85% or greater between 450 nm to 700 nm.

Various embodiments of composite materials, hydrogel materials, and nanoparticles have been described above and are applicable to this aspect of the invention.

Although various embodiments of the invention have been described using specific terms, devices, and methods, such description is for illustrative purposes only. The words used are words of description rather than of limitation. It is to be understood that changes and variations may be made by those skilled in the art without departing from the spirit or scope of the present invention, which is set forth in the following claims. In addition, it should be understood that aspects of the various embodiments may be interchanged either in whole or in part or can be combined in any manner and/or used together, as illustrated below:
1. An embedded contact lens comprising a lens body that has an anterior surface, an opposite posterior surface, and a diameter of from about 12.5 mm to about 15.5 mm, wherein the lens body is composed of a first hydrogel material having a first refractive index in fully-hydrated state and an insert embedded in the first hydrogel material, wherein the insert is circular and concentric with a central axis of the lens body and has a convex surface, an opposite concave surface, and a diameter of from about 5.0 mm to about 11.5 mm, wherein the insert is made of a composite material composed of a second hydrogel material and nanoparticles distributed in the polymer matrix of the second hydrogel material, wherein the nanoparticles are nanocrystals of titanium dioxide or zirconia dioxide and are surface-functionalized to contain reactive or non-reactive functional groups thereon, wherein the insert in fully-hydrated state has a second refractive index that is at least 0.03 higher than the first refractive index and has a visible light transmittance of 85% or greater between about 450 nm and about 700 nm.
2. The embedded contact lens of embodiment 1, wherein the insert has a diameter of from about 5.5 mm to about 10.0 mm.
3. The embedded contact lens of embodiment 1, wherein the insert has a diameter of from about 6.0 mm to about 9.0 mm.
4. The embedded contact lens of any one of embodiments 1 to 3, wherein the insert in fully hydrated state has a second refractive index that is at least 0.04 higher than the first refractive index.
5. The embedded contact lens of any one of embodiments 1 to 3, wherein the insert in fully hydrated state has a second refractive index that is at least 0.05 higher than the first refractive index.
6. The embedded contact lens of any one of embodiments 1 to 3, wherein the insert in fully hydrated state has a second refractive index that is at least 0.06 higher than the first refractive index.
7. The embedded contact lens of any one of embodiments 1 to 6, wherein the insert in fully hydrated state has a visible light transmittance of about 90% or greater between 450 nm to 700 nm.
8. The embedded contact lens of any one of embodiments 1 to 7, wherein the composite material in fully hydrated state has a water content of from about 10% to about 60% by weight.
9. The embedded contact lens of any one of embodiments 1 to 7, wherein the composite material in fully hydrated state has a water content of from about 10% to about 50% by weight.
10. The embedded contact lens of any one of embodiments 1 to 7, wherein the composite material in fully hydrated state has a water content of from about 10% to about 40% by weight.
11. The embedded contact lens of any one of embodiments 1 to 10, wherein the composite material in fully hydrated state has a refractive index of at least 1.44.
12. The embedded contact lens of any one of embodiments 1 to 10, wherein the composite material in fully hydrated state has a refractive index of at least 1.45.
13. The embedded contact lens of any one of embodiments 1 to 10, wherein the composite material in fully hydrated state has a refractive index of at least 1.46.
14. The embedded contact lens of any one of embodiments 1 to 10, wherein the composite material in fully hydrated state has a refractive index of at least 1.47.
15. The embedded contact lens of any one of embodiments 1 to 14, wherein the nanoparticles comprise methacrylate or acrylate groups on surfaces.
16. The embedded contact lens of any one of embodiments 1 to 15, wherein the first and second hydrogel materials comprise repeating units of at least one hydrophilic vinylic monomer.
17. The embedded contact lens of embodiment 16, wherein said at least one hydrophilic vinylic monomer comprises hydroxyethyl (meth)acrylate, glycerol (meth)acrylate, N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, di(ethylene glycol) (meth)acrylate, tri(ethylene glycol) (meth)acrylate, tetra(ethylene glycol) (meth)acrylate, N,N-dimethy (meth)acrylamide, (meth)acrylamide, N-ethyl (meth)acrylamide, N,N-diethyl (meth)acrylamide, N-propyl (meth)acrylamide, N-isopropyl (meth)acrylamide, N-3-methoxy-propyl (meth)acrylamide, N-vinylpyrrolidone, N-vinyl-N-methyl acetamide, N-vinyl-N-ethyl acetamide, N-vinyl-N-ethyl formamide, 1-methyl-3-methylene-2-pyrrolidone, 1-methyl-5-methylene-2-pyrrolidone, -methyl-3-methylene-2-pyrrolidone, N-2-hydroxyethyl vinyl carbamate, N-carboxyvinyl-β-alanine (VINAL), N-carboxyvinyl-α-alanine, a phosphorylcholine-containing vinylic monomer, or combinations thereof.
18. The embedded contact lens of any one of embodiments 1 to 17, wherein the first and second hydrogel materials comprises repeating units of at least one non-silicone vinylic crosslinker.
19. The embedded contact lens of embodiment 18, wherein said at least one non-silicone vinylic crosslinker comprises ethylene glycol di(meth)acrylate; 1,3-propanediol di(meth)acrylate; 2,3-propanediol di(meth)acrylate; 1,3-butanediol di-(meth)acrylate; 1,4-butanediol di(meth)acrylate; glycerol 1,3-diglycerolate di-(meth)acrylate; 1,5-pentanediol di(meth)acrylate; 1,6-hexanediol di(meth)acrylate; diethylene glycol di(meth)acrylate; triethylene glycol di(meth)acrylate; tetraethylene glycol di(meth)acrylate; ethylenebis[oxy(2-hydroxypropane-1,3-diyl)]di-(meth)acrylate; bis[2-(meth)acryloxyethyl]phosphate; 3,4-bis[(meth)acryloyl]tetrahydrofuan; di(meth)acrylamide; N,N-di(meth)acryloyl-N-methylamine; N,N-di(meth)acryloyl-N-ethylamine; N,N′-methylene bis((meth)acrylamide); N,N′-ethylene bis((meth)acrylamide); N,N′-hexamethylene bis-(meth)acrylamide; N,N′-dihydroxyethylene bis(meth)acrylamide; N,N′-propylene bis-(meth)acrylamide; N,N′-2-hydroxypropylene bis(meth)acrylamide; N,N′-2,3-dihydroxy-butylene bis(meth)acrylamide; 1,3-bis(meth)acrylamidepropane-2-yl dihydrogen phosphate; piperazine diacrylamide; pentaerythritol tri(meth)acrylate; trimethyloylpropane tri(meth)acrylate; tris(2-hydroxyethyl)isocyanurate tri(meth)acrylate; 1,3,5-tri(meth)acryloxyl-hexahydro-1,3,5-triazine; pentaerythritol tetra(meth)acrylate; di(trimethyloylpropane)tetra(meth)acrylate; tetraethyleneglycol divinyl ether, triethyleneglycol divinyl ether, diethyleneglycol divinyl ether, ethyleneglycol divinyl ether, triallyl isocyanurate, triallyl cyanurate, allylmethacrylate, allylacrylate, N-allyl-methacrylamide, N-allyl-acrylamide, or combinations thereof.
20. The embedded contact lens of any one of embodiments 1 to 19, wherein the first and second hydrogel materials independent of each other comprises repeating units of at least one no-silicone hydrophobic vinylic monomer.
21. The embedded contact lens of embodiment 20, wherein said at least one non-silicone hydrophobic vinylic monomer comprises methyl (meth)acrylate, ethyl (meth)acrylate, methoxyethyl (meth)acrylate, propyl (meth)acrylate, isopropyl (meth)acrylate, cyclohexyl (meth)acrylate, 2-ethylhexyl (meth)acrylate, isobornyl (meth)acrylate, (meth)acrylonitrile, etc.), 2,2,2-trifluoroethyl (meth)acrylate, tetrafluoropropyl (meth)acrylate, hexafluoro-iso-propyl (meth)acrylate, hexafluorobutyl (meth)acrylate, heptafluorobutyl (meth)acrylate, octafluoropentyl (meth)acrylate, heptadecafluorodecyl (meth)acrylate, pentafluorophenyl (meth)acrylate, vinyl acetate, vinyl propionate, vinyl butyrate, vinyl valerate, vinyl ethyl ether, propyl vinyl ether, n-butyl vinyl ether, isoputyl vinyl ether, cyclohexyl vinyl ether, t-butyl vinyl ether, styrene, vinyl toluene, vinyl chloride, vinylidene chloride, 1-butene, or combinations thereof.
22. The embedded contact lens of any one of embodiments 1 to 21, wherein the first and second hydrogel material independent of each other comprises repeating units of at least one silicone-containing vinylic monomer.
23. The embedded contact lens of embodiment 22, wherein said at least one silicone-containing vinylic monomer comprises a vinylic monomer having a bis(trialkylsilyloxy)alkylsilyl group or a tris(trialkylsilyloxy)silyl group, a polysiloxane vinylic monomer, 3-methacryloxy propylpentamethyldisiloxane, t-butyldimethyl-siloxyethyl vinyl carbonate, trimethylsilylethyl vinyl carbonate, and trimethylsilylmethyl vinyl carbonate, and combinations thereof.
24. The embedded contact lens of any one of embodiments 1 to 23, wherein the first and second hydrogel material independent of each other comprises repeating units of at least one polysiloxane vinylic crosslinker.
25. The embedded contact lens of embodiment 24, wherein said at least one polysiloxane vinylic crosslinker comprises a vinylic crosslinker having one sole polysiloxane segment and two ethylenically unsaturated groups.
26. The embedded contact lens of embodiment 24 or 25, wherein said at least one polysiloxane vinylic crosslinker comprises a chain-extended polysiloxane vinylic crosslinker having at least two polysiloxane segments linked by a linker between each pair of polysiloxane segments and two terminal ethylenically unsaturated groups.
27. The embedded contact lens of embodiment 24, 25 or 26, wherein said at least one polysiloxane vinylic crosslinker comprises a di-(meth)acryloyloxy-terminated polysiloxane vinylic crosslinker having dimethylsiloxane units and hydrophilized siloxane units each having one methyl substituent and one monovalent C₄-C₄₀ organic radical substituent having 2 to 6 hydroxyl groups.
28. The embedded contact lens of any one of embodiments 1 to 27, wherein the second hydrogel material comprises repeating units of at least one aryl vinylic monomer.
29. The embedded contact lens of embodiment 28, wherein said at least one aryl vinylic monomer comprises 2-ethylphenoxy acrylate; 2-ethylphenoxy methacrylate; phenyl (meth)acrylate; benzyl (meth)acrylate; 2-phenylethyl (meth)acrylate; 3-phenylpropyl (meth)acrylate; 4-phenylbutyl (meth)acrylate; 4-methylphenyl (meth)acrylate; 4-methylbenzyl (meth)acrylate; 2-(2-methylphenyl)ethyl (meth)acrylate; 2-(3-methyl-phenyl)ethyl (meth)acrylate; 2-(4-methylphenyl)-ethyl (meth)acrylate; 2-(4-propyl-phenyl)ethyl (meth)acrylate; 2-(4-(1-methylethyl)phenyl)ethyl (meth)acrylate; 2-(4-methoxyphenyl)ethyl (meth)acrylate; 2-(4-cyclohexylphenyl)ethyl (meth)acrylate; 2-(2-chlorophenyl)ethyl (meth)acrylate; 2-(3-chlorophenyl)ethyl (meth)acrylate; 2-(4-chlorophenyl)ethyl (meth)acrylate; 2-(4-bromophenyl)ethyl (meth)acrylate; 2-(3-phenylphenyl)ethyl (meth)acrylate; 2-(4-phenylphenyl)ethyl (meth)acrylate; 2-(4-benzylphenyl)ethyl (meth)acrylate; 2-(phenylthio)ethyl (meth)acrylate; 2-benzyloxyethyl (meth)acrylate; 3-benzyloxypropyl (meth)acrylate; 2-[2-(benzyloxy)ethoxy]-ethyl (meth)acrylate; p-vinylphenyltris(trimethylsiloxy)silane; m-vinylphenyl-tris(trimethylsiloxy) silane; o-vinylphenyltris(trimethylsiloxy)silane; p-styrylethyl-tris(trimethylsiloxy) silane; m-styrylethyl-tris(trimethylsiloxy)silane; o-styrylethyl-tris(trimethylsiloxy) silane; vinyl naphthalene; vinyl anthracene; vinyl phenanthrene; vinyl pyrene; vinyl biphenyl; vinyl terphenyl; vinyl phenyl naphthalene; vinyl phenyl anthracene; vinyl phenyl phenanthrene; vinyl phenyl pyrene; vinyl phenyl terphenyl; phenoxy styrenes; phenyl carbonyl styrenes; phenyl carboxy styrenes; phenoxy carbonyl styrene; allyl naphthalene; allyl anthracene; allyl phenanthrene; allyl pyrene; allyl biphenyl; allyl terphenyl; allyl phenyl naphthalene; allyl phenyl anthracene, allyl phenyl phenanthrene; allyl phenyl pyrene; allyl phenyl terphenyl; allyl phenoxy benzene; allyl(phenylcarbonyl)benzene; allyl phenoxy benzene; allyl(phenyl carbonyl)benzene; allyl(phenylcarboxy)benzene; allyl(phenoxy carbonyl)benzene; styrene; 2,5-dimethylstyrene; 2-(trifluoromethyl) styrene; 2-chlorostyrene; 3,4-dimethoxystyrene; 3-chlorostyrene; 3-bromostyrene; 3-vinylanisole; 3-methylstyrene; 4-bromostyrene; 4-tert-butylstyrene; 2,3,4,5,6-pentanfluorostyrene; 2,4-dimethylstyrene; 1-methoxy-4-vinylbenzene; 1-chloro-4-vinylbenzene; 1-methyl-4-vinylbenzene; 1-(chloromethyl)-4-vinylbenzene; 1-(bromomethyl)-4-vinylbenzene; 3-nitrostyrene; 1,2-vinyl phenyl benzene; 1,3-vinyl phenyl benzene; 1,4-vinyl phenyl benzene; 4-vinyl-1,1′-(4′-phenyl) biphenylene; 1-vinyl-4-(phenyloxy)benzene; 1-vinyl-3-(phenyloxy)-benzene; 1-vinyl-2-(phenyloxy)benzene; 1-vinyl-4-(phenyl carbonyl)benzene; 1-vinyl-3-(phenylcarboxy)benzene; 1-vinyl-2-(phenoxycarbonyl)benzene; allyl phenyl ether; 2-biphenylylallyl ether; allyl 4-phenoxyphenyl ether; allyl 2,4,6-tribromophenyl ether; allyl phenyl carbonate; 1-allyloxy-2-trifluoromethylbenzene; allylbenzene; 1-phenyl-2-prop-2-enylbenzene; 4-phenyl-1-butene; 4-phenyl-1-butene-4-ol; 1-(4-methylphenyl)-3-buten-1-ol; 1-(4-chlorophenyl)-3-buten-1-ol, 4-allyltoluene; 1-allyl-4-fluorobenzene; 1-allyl-2-methyl-benzene; 1-allyl-3-methylbenzene; 1-allyl-3-methylbenzene; 2-allylanisole; 4-allylanisole; 1-allyl-4-(trifluromethyl)benzene; allylpentafluorobenzene; 1-allyl-2-methoxybenzene; 4-allyl-1,2-dimethoxybenzene; 2-allylphenol; 2-allyl-6-methylphenol; 4-allyl-2-methoxyphenol; 2-allyloxyanisole; 4-allyl-2-methoxyphenyl acetate; 2-allyl-6-methoxyphenol; 1-allyl-2-bromobezene; alpha-vinylbenzyl alcohol; 1-phenyl-3-butene-1-one; allylbenzyl ether; (3-allyloxy)propyl)benzene; allyl phenylethyl ether; 1-benzyloxy-4-pentene; (1-allyloxy)ethyl)-benzene; 1-phenylallyl ethyl ether; (2-methyl-2-(2-propenyloxy)propyl)benzene; ((5-hexenyloxy)methyl)benzene; 1-allyloxy-4-propoxybenzene; 1-phenoxy-4-(3-prop-2-enoxypropoxy)benzene; 6-(4′-Hydroxy-phenoxy)-1-Hexene; 4-but-3-enoxyphenol; 1-allyloxy-4-butoxybenzene; 1-allyloxy-4-ethoxybenzene; 1-allyl-4-benzyloxybenzene; 1-allyl-4-(phenoxy)benzene; 1-allyl-3-(phenoxy)benzene; 1-allyl-2-(phenoxy)benzene; 1-allyl-4-(phenyl carbonyl)benzene; 1-allyl-3-(phenyl carboxy)benzene; 1-allyl-2-(phenoxycarbonyl)-benzene; 1,2-allyl phenyl benzene; 1,3-allyl phenyl benzene; 1,4-allyl phenyl benzene; 4-vinyl-1,1′-(4′-phenyl)-biphenylene; 1-allyl-4-(phenyloxy)benzene; 1-allyl-3-(phenyloxy)-benzene; 1-allyl-2-(phenyloxy)benzene; 1-allyl-4-(phenyl carbonyl)benzene; 1-allyl-3-(phenyl carboxy)benzene; 1-allyl-2-(phenoxycarbonyl)benzene; 1-vinyl naphthylene; 2-vinyl naphthylene; 1-allyl naphthalene; 2-allyl naphthalene; allyl-2-naphthyl ether; 2-(2-methylprop-2-enyl) naphthalene; 2-prop-2-enylnaphthalene; 4-(2-naphthyl)-1-butene; 1-(3-butenyl) naphthalene; 1-allyl naphthalene; 2-allyl naphthalene; 1-allyl-4-napthyl naphthalene; 2-(allyloxy)-1-bromonaphthalene; 2-bromo-6-allyloxynaphthalene; 1,2-vinyl(1-naphthyl)-benzene; 1,2-vinyl(2-naphthyl)benzene; 1,3-vinyl(1-naphthyl)benzene; 1,3-vinyl(2-naphthyl)-benzene; 1,4-vinyl(1-naphthyl)benzene; 1,4-vinyl(2-naphthyl)benzene; 1-naphthyl-4-vinyl naphthalene; 1-allyl naphthalene; 2-allyl naphthalene; 1,2-allyl(1-naphthyl)benzene; 1,2-allyl(2-naphthyl)benzene; 1,3-allyl(1-naphthyl)benzene; 1,3-allyl(2-naphthyl)benzene; 1,4-allyl(1-naphthyl)benzene; 1,4-allyl(2-naphthyl)benzene; 1-allyl-4-napthyl naphthalene; 1-vinyl anthracene; 2-vinyl anthracene; 9-vinyl anthracene; 1-allyl anthracene; 2-allyl anthracene; 9-allyl anthracene; 9-pent-4-enylanthracene; 9-allyl-1,2,3,4-tetrachloroanthracene; 1-vinyl phenanthrene; 2-vinyl phenanthrene; 3-vinyl phenanthrene; 4-vinyl phenanthrene; 9-vinyl phenanthrene; 1-allyl phenanthrene; 2-allyl phenanthrene; 3-allyl phenanthrene; 4-allyl phenanthrene; 9-allyl phenanthrene; or combinations thereof.
30. The embedded contact lens of embodiment 28, wherein said at least one aryl vinylic monomer comprises 2-phenylethyl acrylate; 3-phenylpropyl acrylate; 4-phenylbutyl acrylate; 5-phenylpentyl (meth)acrylate; 2-benzyloxyethyl (meth)acrylate; 3-benzyloxypropyl (meth)acrylate; 2-[2-(benzyloxy)ethoxy]ethyl (meth)acrylate; p-vinylphenyl-tris(trimethylsiloxy)silane; m-vinylphenyltris(trimethylsiloxy)silane; o-vinylphenyl-tris(trimethyl-siloxy)silane; p-styrylethyltris(trimethylsiloxy)silane; m-styrylethyl-tris(trimethylsiloxy)silane; o-styrylethyltris(trimethylsiloxy)silane; or combinations thereof. Most preferred are p-vinylphenyltris(trimethylsiloxy)silane; m-vinylphenyl-tris(trimethylsiloxy)silane; o-vinylphenyl-tris(trimethylsiloxy)silane; p-styrylethyl-tris(trimethylsiloxy)silane; m-styrylethyl-tris(trimethyl-siloxy)silane; o-styrylethyl-tris(trimethylsiloxy)silane; or combinations thereof.
31. The embedded contact lens of any one of embodiments 1 to 30, wherein the second hydrogel material comprises repeating units of at least one non-silicone aryl vinylic crosslinker.
32. The embedded contact lens of embodiment 31, wherein said at least one non-silicone aryl vinylic crosslinker comprises divinylbenzene, 2-methyl-1,4-divinylbenzene, bis(4-vinylphenyl) methane, 1,2-bis(4-vinylphenyl) ethane, or combinations thereof.
33. The embedded contact lens of any one of embodiments 1 to 32, wherein the second hydrogel material comprises repeating units of at least one aryl-containing polysiloxane vinylic crosslinker.
34. The embedded contact lens of embodiment 33, wherein said at least one aryl-containing polysiloxane vinylic crosslinker comprises a polysiloxane vinylic crosslinker that comprises: (1) a polysiloxane segment comprising dimethylsiloxane units and aryl-containing siloxane units each having at least one aryl-containing substituent having up to 45 carbon atoms; and (2)ethylenically-unsaturated groups.
35. The embedded contact lens of embodiment 33 or 34, wherein said at least one aryl-containing polysiloxane vinylic crosslinker comprises a vinyl terminated polyphenylmethysiloxane, a vinylphenylmethyl terminated phenylmethyl-vinylphenylsiloxane copolymer, a vinyl terminated diphenylsiloxane-dimethylsiloxane copolymer, a (meth)acryloxyalkyl-terminated polyphenylmethysiloxane, a (meth)acryloxyalkyl-terminated phenylmethyl-vinylphenylsiloxane copolymer, a (meth)acryloxyalkyl-terminated diphenylsiloxane-dimethylsiloxane copolymer, an ethylenically-unsaturated group-terminated dimethylsiloxane-arylmethylsiloxane copolymer, or combinations thereof.
36. The embedded contact lens of any one of embodiments 1 to 35, wherein the convex surface of the insert merges with the anterior surface of the lens body whereas the concave surface of the insert is buried beneath the posterior surface of the lend body, wherein the curvature of the convex surface of the insert is identical to the curvature of a central zone of the anterior surface, wherein the central zone has a diameter of the insert.
37. The embedded contact lens of embodiment 36, wherein the insert comprises a diffractive optics on the concave surface of the insert.
38. The embedded contact lens of any one of embodiments 1 to 35, wherein the concave surface of the insert merges with the anterior surface of the lens body whereas the convex surface of the insert is buried beneath the posterior surface of the lend body, wherein the curvature of the concave surface of the insert is identical to the curvature of a central zone of the posterior surface, wherein the central zone has a diameter of the insert.
39. The embedded contact lens of embodiment 38, wherein the insert comprises a diffractive optics on the convex surface of the insert.
40. The embedded contact lens of any one of embodiments 1 to 35, wherein the convex surface of the insert is buried beneath the anterior surface of the lens body at a first depth whereas the concave surface of the insert is buried beneath the posterior surface of the lens body at a second depth, wherein the first depth and the second depth independent of each other are 10 microns or larger.
41. The embedded contact lens of embodiment 40, wherein the insert comprises a diffractive optics on the concave surface of the insert.
42. The embedded contact lens of any one of embodiments 1 to 35, wherein the insert comprises a diffractive optics on one of the convex and concave surfaces of the insert.
43. The embedded contact lens of any one of embodiments 1 to 42, wherein embedded contact lens comprises a non-silicone hydrogel coating on the anterior and posterior surfaces of the lens body.
44. An hydrogel ophthalmic device that is a contact lens or an insert, wherein the hydrogel ophthalmic device is made of a composite material composed of a hydrogel material and nanoparticles distributed in the polymer matrix of the hydrogel material, wherein the nanoparticles are nanocrystals of titanium dioxide or zirconia dioxide and are surface-functionalized to contain reactive or non-reactive functional groups thereon, wherein the composite material in fully hydrated state has a refractive index of at least 1.44, a visible light transmittance of 85% or greater between 450 nm to 700 nm, and a water content of from about 10% to about 60% by weight.
45. The hydrogel ophthalmic device of embodiment 44, wherein the composite material in fully hydrated state has a refractive index of at least 1.45.
46. The hydrogel ophthalmic device of embodiment 44, wherein the composite material in fully hydrated state has a refractive index of at least 1.46.
47. The hydrogel ophthalmic device of embodiment 44, wherein the composite material in fully hydrated state has a refractive index of at least 1.47.
48. The hydrogel ophthalmic device of embodiment 44, wherein the composite material in fully hydrated state has a refractive index of at least 1.48.
49. The hydrogel ophthalmic device of any one of embodiments 44 to 48, wherein the composite material in fully hydrated state has a visible light transmittance of about 90% or greater between 450 nm to 700 nm.
50. The hydrogel ophthalmic device of any one of embodiments 44 to 49, wherein the nanoparticles comprise methacrylate or acrylate groups on surfaces.
51. The hydrogel ophthalmic device of any one of embodiments 44 to 50, wherein the hydrogel material comprises repeating units of at least one hydrophilic vinylic monomer and repeating units of at least polymerizable component selected from the group consisting of at least non-silicone vinylic crosslinker, at least one non-silicone hydrophobic vinylic monomer, at least one silicone-containing vinylic monomer, at least one polysiloxane vinylic crosslinker, at least one aryl vinylic monomer, at least one non-silicone aryl vinylic crosslinker, at least one aryl-containing polysiloxane vinylic crosslinker, and combinations thereof.

The previous disclosure will enable one having ordinary skill in the art to practice the invention. Various modifications, variations, and combinations can be made to the various embodiment described herein. In order to better enable the reader to understand specific embodiments and the advantages thereof, reference to the following examples is suggested. It is intended that the specification and examples be considered as exemplary.

### Example 1

### Oxygen Permeability Measurements

Unless specified, the oxygen transmissibility (Dk/t), the intrinsic (or edge-corrected) oxygen permeability (Dkᵢ or Dk_{c}) of a lens and a lens material are determined according to procedures described in ISO 18369-4.

### Equilibrium Water Content

The equilibrium water content (EWC) of contact lenses are determined as follows.

Amount of water (expressed as percent by weight) present in a hydrated hydrogel contact lens, which is fully equilibrated in saline solution, is determined at room temperature. Quickly stack the lenses and transfer the lens stack to the aluminum pan on the analytical balance after blotting lens in a cloth. The number of lenses for each sample pan is typically five (5). Record the pan plus hydrated weight of the lenses. Cover the pan with aluminum foil. Place pans in a laboratory oven at 100±2° C. to dry for 16-18 hours. Remove pan plus lenses from the oven and cool in a desiccator for at least 30 minutes. Remove a single pan from the desiccator and discard the aluminum foil. Weigh the pan plus dried lens sample on an analytical balance. Repeat for all pans. The wet and dry weight of the lens samples can be calculated by subtracting the weight of the empty weigh pan.

### Elastic Modulus

The storage modulus (Young's modulus) of inserts is determined using a TA RSA-G2 DMA (Dynamic Mechanical Analyzer). The insert is cut into a 3.08 mm wide strip using Precision Concept dry lens cutter. Five thickness values are measured within 6.5 mm gauge length. The strip is mounted on the instrument with metal grips. Oscillation temperature ramp test with a linear ramping rate at 2° C./minute from 10° C.˜50° C. is applied on the insert, the material response to increasing temperature is monitored at a constant frequency of 1 Hz, constant amplitude of 0.5% deformation and sampling rate of 10.0 pts/s. Storage modulus (E′), loss modulus (E″) and tan δ data are calculated by TRIOS software.

The elastic modulus of a contact lens is determined using an MTS insight instrument. The contact lens is first cut into a 3.12 mm wide strip using Precision Concept two stage cutter. Five thickness values are measured within 6.5 mm gauge length. The strip is mounted on the instrument grips and submerged in PBS (phosphate buffered saline) with the temperature controlled at 21±2° C. Typically 5N Load cell is used for the test. Constant force and speed is applied to the sample until the sample breaks. Force and displacement data are collected by the TestWorks software. The elastic modulus value is calculated by the TestWorks software which is the slope or tangent of the stress vs. strain curve near zero elongation, in the elastic deformation region.

### Refractive Index

The refractive index (RI) of inserts is determined by Abbe transmission laboratory refractometer Reichert Abbe Mark III at 25° C. The inserts are fully equilibrated in PBS saline solution before measurement.

### Determination of Diameter of Hydrated Contact Lenses and Inserts

FIG. 4 shows schematically the general lens dimensions which are typically determined by a contact lens manufacturer. The general dimensions include center thickness (CT) (410), anterior sagittal height (ASag) (420), posterior sagittal height (PSag) (440), base curve equivalent (BCE) (450), edge thickness (ET) (460), and diameter (480). Measurements of the general lens dimensions can be carried out on fully hydrated contact lenses in a wetcell by using a low coherence interferometer similar to that described by Heidemana and Greivenkampin in their paper (Optical Engineering 55(3), 034106 (March 2016)).

For measurements, a contact lens is seated on the flat bottom surface of the wetcell which is filled with a phosphate buffered saline and a low coherence interferometer is placed at the geometric center of the lens using a motion controller. The interferometer measures thicknesses of material based off of reflections between different material surfaces. The center of the lens is determined by the measurement by the camera.

The Diameter is defined as the width of the outermost edge of the lens viewed from above the lens. The edge points are fit to an ellipse and the diameter is calculated as the average of the major and minor ellipse diameters. Typically, contact lenses have highly circular diameters and either a circular or elliptical fitting will result in similar values. However, if a lens is slightly out of round, an ellipse more accurately describes the shape of the contact lens diameter than a circle. The lens diameters of 3 to 10 contact lenses from one single batch of contact lenses are measured and averaged to obtain the averaged lens diameter for that batch of contact lenses.

The diameter of an insert can also be measured as described above for contact lenses.

### Chemicals

The following abbreviations are used in the following examples: HEMA represents 2-hydroxyethyl methacrylate; EGDMA represent ethyleneglycol dimethacrylate; TEGDMA represent triethyleneglycol dimethacrylate; DMA represents N,N-dimethyl acrylamide; PrOH represents 1-propanol; ETA represents ethyl acetate; Irgacure 1173 represents a photoinitiator made of 2-hydroxy-2-methyl-1-phenylpropanone; PBS represents a phosphate-buffered saline which has a pH of 7.2±0.2 at 25° C. and contains about 0.044 wt. % NaH₂PO₄·H₂O, about 0.388 wt. % Na₂HPO₄·2H₂O, and about 0.79 wt. % NaCl; wt. % represents weight percent; and D2 represents a di-methacryloyloxypropyl-terminated polysiloxane (Mn˜8.0 KDa, υ1˜65, ω˜15) of formula (A) shown below.

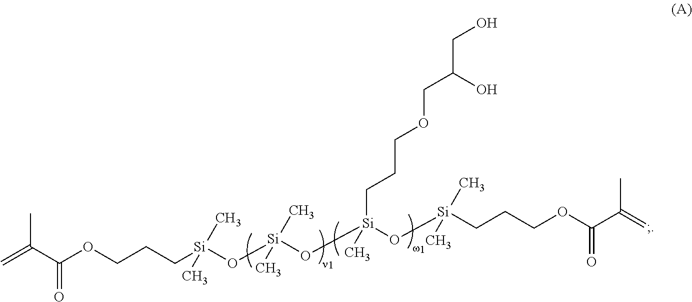

### Example 2

### Lens Made of Composite Material

Lenses made of composite material composed of a hydrogel material and nanoparticles distributed in the polymer matrix of the hydrogel material are prepared by cast-molding and UV-curing of the compositions listed in Table 1.

Nanoparticles-containing formulations are prepared by combining the following ingredients: HEMA, EGDMA, PrOH, Irgacure 1173, and zirconia dispersions to achieve the final compositions listed in Table 1. Two types of methacrylate-functionalized zirconia dispersions (50 wt % solid in ETA) are used: PCPB-2-50-ETA and PCPC-1-50-ETA. The former product is noted to have a medium methacrylate coverage and the latter have a high coverage. The ETA is evaporated from a mixture of HEMA and the PCPB or PCPC dispersions before the remaining ingredients are added.

TABLE 1

| | Composition (wt %) | | | | | | |
|---|---|---|---|---|---|---|---|
| | | | | | Irgacure | Properties | |
| Sample ID | HEMA | EGDMA | ZrO₂ | PrOH | 1173 | RI | EWC (%) |
| HEMA-PB-20 | 0.5694 | 0.006 | 0.2189 | 0.2 | 0.006 | 1.4759 | 0.2839 |
| HEMA-PB-31 | 0.4790 | 0.005 | 0.3102 | 0.2 | 0.006 | 1.4907 | 0.2548 |
| HEMA-PB-41 | 0.3776 | 0.004 | 0.4127 | 0.2 | 0.006 | 1.5101 | 0.2151 |
| HEMA-PB-53 | 0.2622 | 0.003 | 0.5292 | 0.2 | 0.006 | 1.5410 | 0.1601 |
| HEMA-PC-22 | 0.5712 | 0.006 | 0.2171 | 0.2 | 0.006 | 1.4703 | 0.2884 |
| HEMA-PC-31 | 0.4802 | 0.005 | 0.3090 | 0.2 | 0.006 | 1.4869 | 0.2569 |
| HEMA-PC-41 | 0.3759 | 0.004 | 0.4143 | 0.2 | 0.006 | 1.5160 | 0.2291 |
| HEMA-PC-54 | 0.2553 | 0.003 | 0.5361 | 0.2 | 0.006 | 1.5472 | 0.1849 |

The lens-forming composition is dispensed into the molding surface of a female mold made of polypropylene, after which it is closed with a male mold half which is also made of polypropylene. The formed subassembly is then cured using a LED curebox equipped with 365 nm illumination for 12 minutes at room temperature. The subassembly containing cured composite hydrogel is mechanically opened. Molded composite hydrogels adhering to the female mold halves are delensed manually and those adhering to the male mold halves are floated off by hydrating briefly in DI water before being manually delensed.

The delensed composite hydrogel are extracted with DI water overnight at room temperature, then one-to-two baths of PBS solutions at room temperature for 60 minutes; packed/sealed in polypropylene lens packaging shells with 0.85 mL of PBS; and finally autoclaved for 45 minutes at 121° C.

The obtained composite hydrogel lenses are characterized for refractive index, clarity and equilibrium water content. The results are reported in Table 1

### Example 3

Bilayer Lens where the High Refractive Index Layer is a Composite Hydrogel Material.

High refractive index composite hydrogel inserts (RI=1.49) are prepared by UV cast-molding of an insert-forming composition: HEMA 45 parts, EDGMA 0.7 parts, ZrO₂ solid 33 parts, PrOH 20 parts, Irgacure 1173 0.8 parts.

Carrier (bulk) forming composition. Two carrier lens forming composition, one HEMA and one SiHy lens formulation, are prepared by combining and mixing all lens forming components. The first carrier-forming composition HEMAC21 has the following components: HEMA 71 parts, EGDMA 2 parts, EGBE 29 parts, Irgacure 1173 1.0 parts and is cured for 5 minutes at 1˜3 mW/cm². The second carrier-forming composition SiHyD2 has the following components: D2 (glycerol-side chain silicone macromer) 45 parts, DMA 22.5 parts, PrOH 40 parts, Irgacure 1173 1.0 parts and is cured for 2 mins at 7.6 mW/cm² under 365 nm UV-LED light.

All the publications, patents, and patent application publications, which have been cited herein above, are hereby incorporated by reference in their entireties.

What is claimed is:

1. An embedded contact lens comprising a lens body that has an anterior surface, an opposite posterior surface, and a diameter of from about 12.5 mm to about 15.5 mm, wherein the lens body is composed of a first hydrogel material having a first refractive index in fully-hydrated state and an insert embedded in the first hydrogel material, wherein the insert is circular and concentric with a central axis of the lens body and has a convex surface, an opposite concave surface, and a diameter of from about 5.0 mm to about 11.5 mm, wherein the insert is made of a composite material composed of a second hydrogel material and nanoparticles distributed in the polymer matrix of the second hydrogel material, wherein the nanoparticles are nanocrystals of titanium dioxide or zirconia dioxide and are surface-functionalized to contain reactive or non-reactive functional groups thereon, wherein the insert in fully-hydrated state has a second refractive index that is at least 0.03 higher than the first refractive index and has a visible light transmittance of 85% or greater between 450 nm to 700 nm.

2. The embedded contact lens of claim 1, wherein the nanoparticles comprise methacrylate or acrylate groups on surfaces.

3. The embedded contact lens of claim 2, wherein the first and second hydrogel materials comprise: (a) repeating units of at least one hydrophilic vinylic monomer; (b) repeating units of at least one polymerizable component selected from the group consisting of (i) at least one non-silicone vinylic crosslinker, (ii) at least one no-silicone hydrophobic vinylic monomer, and (iii) combination thereof.

4. The embedded contact lens of claim 3, wherein said at least one hydrophilic vinylic monomer comprises hydroxyethyl (meth)acrylate, glycerol (meth)acrylate, N-2-hydroxylethyl (meth)acrylamide, N,N-bis(hydroxyethyl) (meth)acrylamide, N-3-hydroxypropyl (meth)acrylamide, N-2-hydroxypropyl (meth)acrylamide, N-2,3-dihydroxypropyl (meth)acrylamide, di(ethylene glycol) (meth)acrylate, tri(ethylene glycol) (meth)acrylate, tetra(ethylene glycol) (meth)acrylate, N,N-dimethy (meth)acrylamide, (meth)acrylamide, N-ethyl (meth)acrylamide, N,N-diethyl (meth)acrylamide, N-propyl (meth)acrylamide, N-isopropyl (meth)acrylamide, N-3-methoxy-propyl (meth)acrylamide, N-vinylpyrrolidone, N-vinyl-N-methyl acetamide, N-vinyl-N-ethyl acetamide, N-vinyl-N-ethyl formamide, 1-methyl-3-methylene-2-pyrrolidone, 1-methyl-5-methylene-2-pyrrolidone, -methyl-3-methylene-2-pyrrolidone, N-2-hydroxyethyl vinyl carbamate, N-carboxyvinyl-β-alanine (VINAL), N-carboxyvinyl-α-alanine, a phosphorylcholine-containing vinylic monomer, or combinations thereof,
wherein said at least one non-silicone vinylic crosslinker comprises ethylene glycol di(meth)acrylate; 1,3-propanediol di(meth)acrylate; 2,3-propanediol di(meth)acrylate; 1,3-butanediol di-(meth)acrylate; 1,4-butanediol di(meth)acrylate; glycerol 1,3-diglycerolate di-(meth)acrylate; 1,5-pentanediol di(meth)acrylate; 1,6-hexanediol di(meth)acrylate; diethylene glycol di(meth)acrylate; triethylene glycol di(meth)acrylate; tetraethylene glycol di(meth)acrylate; ethylenebis[oxy(2-hydroxypropane-1,3-diyl)]di-(meth)acrylate; bis[2-(meth)acryloxyethyl]phosphate; 3,4-bis[(meth)acryloyl]tetrahydrofuan; di(meth)acrylamide; N,N-di(meth)acryloyl-N-methylamine; N,N-di(meth)acryloyl-N-ethylamine; N,N′-methylene bis((meth)acrylamide); N,N′-ethylene bis((meth)acrylamide); N,N′-hexamethylene bis-(meth)acrylamide; N,N′-dihydroxyethylene bis(meth)acrylamide; N,N′-propylene bis-(meth)acrylamide; N,N′-2-hydroxypropylene bis(meth)acrylamide; N,N′-2,3-dihydroxy-butylene bis(meth)acrylamide; 1,3-bis(meth)acrylamidepropane-2-yl dihydrogen phosphate; piperazine diacrylamide; pentaerythritol tri(meth)acrylate; trimethyloylpropane tri(meth)acrylate; tris(2-hydroxyethyl)isocyanurate tri(meth)acrylate; 1,3,5-tri(meth)acryloxyl-hexahydro-1,3,5-triazine; pentaerythritol tetra(meth)acrylate; di(trimethyloylpropane)tetra(meth)acrylate; tetraethyleneglycol divinyl ether, triethyleneglycol divinyl ether, diethyleneglycol divinyl ether, ethyleneglycol divinyl ether, triallyl isocyanurate, triallyl cyanurate, allylmethacrylate, allylacrylate, N-allyl-methacrylamide, N-allyl-acrylamide, or combinations thereof,
wherein said at least one non-silicone hydrophobic vinylic monomer comprises methyl (meth)acrylate, ethyl (meth)acrylate, methoxyethyl (meth)acrylate, propyl (meth)acrylate, isopropyl (meth)acrylate, cyclohexyl (meth)acrylate, 2-ethylhexyl (meth)acrylate, isobornyl (meth)acrylate, (meth)acrylonitrile, etc.), 2,2,2-trifluoroethyl (meth)acrylate, tetrafluoropropyl (meth)acrylate, hexafluoro-iso-propyl (meth)acrylate, hexafluorobutyl (meth)acrylate, heptafluorobutyl (meth)acrylate, octafluoropentyl (meth)acrylate, heptadecafluorodecyl (meth)acrylate, pentafluorophenyl (meth)acrylate, vinyl acetate, vinyl propionate, vinyl butyrate, vinyl valerate, vinyl ethyl ether, propyl vinyl ether, n-butyl vinyl ether, isoputyl vinyl ether, cyclohexyl vinyl ether, t-butyl vinyl ether, styrene, vinyl toluene, vinyl chloride, vinylidene chloride, 1-butene, or combinations thereof.

5. The embedded contact lens of claim 3, wherein the first and second hydrogel material independent of each other comprises repeating units of at least one silicone-containing vinylic monomer which is a vinylic monomer having a bis(trialkylsilyloxy)alkylsilyl group or a tris(trialkylsilyloxy)silyl group, a polysiloxane vinylic monomer, 3-methacryloxy propylpentamethyldisiloxane, t-butyldimethyl-siloxyethyl vinyl carbonate, trimethylsilylethyl vinyl carbonate, and trimethylsilylmethyl vinyl carbonate, or combinations thereof.

6. The embedded contact lens of claim 5, wherein the first and second hydrogel material independent of each other comprises repeating units of at least one polysiloxane vinylic crosslinker.

7. The embedded contact lens of claim 3, wherein the second hydrogel material comprises repeating units of at least one aryl vinylic monomer and/or at least one aryl vinylic crosslinker.

8. The embedded contact lens of claim 6, wherein the second hydrogel material comprises repeating units of at least one aryl-containing polysiloxane vinylic crosslinker.

9. The embedded contact lens of claim 8, wherein said at least one aryl-containing polysiloxane vinylic crosslinker comprises a polysiloxane vinylic crosslinker that comprises: (1) a polysiloxane segment comprising dimethylsiloxane units and aryl-containing siloxane units each having at least one aryl-containing substituent having up to 45 carbon atoms; and (2) ethylenically-unsaturated groups.

10. The embedded contact lens of claim 8, wherein said at least one aryl-containing polysiloxane vinylic crosslinker comprises a vinyl terminated polyphenylmethysiloxane, a vinylphenylmethyl terminated phenylmethyl-vinylphenylsiloxane copolymer, a vinyl terminated diphenylsiloxane-dimethylsiloxane copolymer, a (meth)acryloxyalkyl-terminated polyphenylmethysiloxane, a (meth)acryloxyalkyl-terminated phenylmethyl-vinylphenylsiloxane copolymer, a (meth)acryloxyalkyl-terminated diphenylsiloxane-dimethylsiloxane copolymer, an ethylenically-unsaturated group-terminated dimethylsiloxane-arylmethylsiloxane copolymer, or combinations thereof.

11. The embedded contact lens of claim 3, wherein the convex surface of the insert merges with the anterior surface of the lens body whereas the concave surface of the insert is buried beneath the posterior surface of the lend body, wherein the curvature of the convex surface of the insert is identical to the curvature of a central zone of the anterior surface, wherein the central zone has a diameter of the insert, wherein the insert comprises a diffractive optics on the concave surface of the insert.

12. The embedded contact lens of claim 3, wherein the concave surface of the insert merges with the anterior surface of the lens body whereas the convex surface of the insert is buried beneath the posterior surface of the lend body, wherein the curvature of the concave surface of the insert is identical to the curvature of a central zone of the posterior surface, wherein the central zone has a diameter of the insert, wherein the insert comprises a diffractive optics on the convex surface of the insert.

13. The embedded contact lens of claim 3, wherein the convex surface of the insert is buried beneath the anterior surface of the lens body at a first depth whereas the concave surface of the insert is buried beneath the posterior surface of the lens body at a second depth, wherein the first depth and the second depth independent of each other are 10 microns or larger, wherein the insert comprises a diffractive optics on the concave surface of the insert.

14. The embedded contact lens of claim 8, wherein embedded contact lens comprises a non-silicone hydrogel coating on the anterior and posterior surfaces of the lens body.

15. An hydrogel ophthalmic device that is a contact lens or an insert, wherein the hydrogel ophthalmic device is made of a composite material composed of a hydrogel material and nanoparticles distributed in the polymer matrix of the hydrogel material, wherein the nanoparticles are nanocrystals of titanium dioxide or zirconia dioxide and are surface-functionalized to contain reactive or non-reactive functional groups thereon, wherein the composite material in fully hydrated state has a refractive index of at least 1.46, a visible light transmittance of 85% or greater between 450 nm to 700 nm, and a water content of from about 10% to about 60% by weight.

16. The hydrogel ophthalmic device of claim 15, wherein the nanoparticles comprise methacrylate or acrylate groups on surfaces.

17. The hydrogel ophthalmic device of claim 16, wherein the hydrogel material comprises repeating units of at least one hydrophilic vinylic monomer and repeating units of at least polymerizable component selected from the group consisting of at least non-silicone vinylic crosslinker, at least one non-silicone hydrophobic vinylic monomer, at least one silicone-containing vinylic monomer, at least one polysiloxane vinylic crosslinker, at least one aryl vinylic monomer, at least one non-silicone aryl vinylic crosslinker, at least one aryl-containing polysiloxane vinylic crosslinker, and combinations thereof.
